(19) United States
(12) Patent Application Publication
(10) Pub. No.: US 2012/0222421 A1
(43) Pub. Date: Sep. 6, 2012

(54) SOLAR ENERGY GAS TURBINE

(76) Inventor: James HANNA, Bethlehem, PA (US)

(21) Appl. No.: 13/293,760

(22) Filed: Nov. 10, 2011

Related U.S. Application Data
(60) Provisional application No. 61/412,215, filed on Nov. 10, 2010.

(51) Int. Cl. F03G 6/06

(52) U.S. Cl. 60/641.15

(57) ABSTRACT

The invention is directed to a solar energy system includes a sun tracking lens mounted on a frame. The system further includes a support system to support the solar energy system, a heat exchanger configured so that concentrated light from the lens is focused on the heat exchanger, a boiler, a double chamber scroll compressor, a turbine arranged in the support system, and a generator unit arranged in the support system.

### CROSS REFERENCE TO PRIOR APPLICATIONS

This application claims the benefit of U.S. Provisional Patent Application No. 61/412,215 filed on Nov. 10, 2010, which is hereby incorporated by reference in its entirety for all purposes as if fully set forth herein.

### BACKGROUND OF THE DISCLOSURE

1. Field of the Disclosure

This disclosure is directed to a solar energy system that generates heat and produces electricity, hot water, plus hot & cold air for air conditioning and more particularly to a solar energy system that efficiently generates heat and produces electricity, with a turbine.

2. Related Art

Traditional solar energy systems, such as photo voltaic systems, do not efficiently generate electricity and are not cost-effective source of heat.

Accordingly, there is a need for a more efficient solar energy system.

### SUMMARY OF THE DISCLOSURE

According to an aspect of the disclosure, a solar energy system includes a sun tracking lens mounted on a frame, a support system to support the solar energy system, a heat exchanger configured so that concentrated light from the lens is focused on the heat exchanger, a boiler, a double chamber scroll compressor, a turbine arranged in the support system, and a generator unit arranged in the support system.

According to another aspect of the disclosure, a solar energy system includes a sun tracking Fresnel lens mounted on a swivel mounted frame, a support system to support the solar energy system, a heat exchanger configured so that concentrated light from the lens is focused on the heat exchanger, a turbine arranged in the support system, a boiler, and a generator unit arranged in the support system, wherein the sun tracking lens comprises a circular shape.

Additional features, advantages, and embodiments of the disclosure may be set forth or apparent from consideration of the following detailed description, drawings, and claims. Moreover, it is to be understood that both the foregoing summary of the disclosure and the following detailed description are exemplary and intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced. In the drawings:

FIG. 1 shows a solar energy system constructed according to the principles of the disclosure.

FIG. 2 shows a side elevation of a solar unit constructed according to the principles of the disclosure.

FIG. 3 shows a side elevation inside a pipe support constructed according to the principles of the disclosure.

FIG. 4 shows a front elevation of a solar unit constructed according to the principles of the disclosure.

FIG. 5 shows a full height vertical section thru a unit constructed according to the principles of the disclosure.

FIG. 6 shows a plan solar tracking unit frame constructed according to the principles of the disclosure.

FIG. 7 shows a plan solar tracking unit bracket constructed according to the principles of the disclosure.

FIG. 8 shows a section solar tracking unit bracket & stepping motor #3 constructed according to the principles of the disclosure.

FIG. 9 shows a plan rotational bearing setting constructed according to the principles of the disclosure.

FIG. 10 shows a plan stepping motor #2 constructed according to the principles of the disclosure.

FIG. 11 shows a plan electronic center constructed according to the principles of the disclosure.

FIG. 12 shows an electronic center circuit diagram constructed according to the principles of the disclosure.

FIG. 13 shows a plan battery constructed according to the principles of the disclosure.

FIG. 14 shows a plan compressor lid constructed according to the principles of the disclosure.

FIG. 15 shows a plan compressor stage 1 constructed according to the principles of the disclosure.

FIG. 16 shows a plan turbine manifold constructed according to the principles of the disclosure.

FIG. 17 shows a plan turbine i constructed according to the principles of the disclosure.

FIG. 18 shows a plan turbine ii constructed according to the principles of the disclosure.

FIG. 19 shows a plan generator control center constructed according to the principles of the disclosure.

FIG. 20 shows a plan generator constructed according to the principles of the disclosure.

FIG. 21 shows a plan califont constructed according to the principles of the disclosure.

FIG. 22 shows a plan AC fan constructed according to the principles of the disclosure.

FIG. 23 shows a plan AC unit constructed according to the principles of the disclosure.

FIG. 24 shows a plan AC stepping motor #3 constructed according to the principles of the disclosure.

FIG. 25 shows a plan AC unit damper flap constructed according to the principles of the disclosure.

FIG. 26 shows a plan unit pipe support constructed according to the principles of the disclosure.

FIG. 27 shows a solar lens & frame (referenced as SC) constructed according to the principles of the disclosure.

FIG. 28 shows a heat exchanger Pyrex cover (referenced as HE) constructed according to the principles of the disclosure.

FIG. 29 shows a heat exchanger shield (referenced as HE) constructed according to the principles of the disclosure.

FIG. 30 shows heat exchanger coils (referenced as HE) constructed according to the principles of the disclosure.

FIG. 31 shows a boiler & lens swivel bracket (referenced as BL) constructed according to the principles of the disclosure.

FIG. 32 shows a compressor housing (referenced as CR) constructed according to the principles of the disclosure.

FIG. 33 shows compressor top, middle & bottom plates constructed according to the principles of the disclosure.

FIG. 34 shows a compressor fixed spiral constructed according to the principles of the disclosure.

FIG. 35 shows a compressor rotating spiral constructed according to the principles of the disclosure.

FIG. 36 shows a compressor rotating positions constructed according to the principles of the disclosure.

FIG. 37 shows a turbine housing vertical section (referenced as TT) constructed according to the principles of the disclosure.

FIG. 38 shows a turbine housing plan constructed according to the principles of the disclosure.

FIG. 39 shows turbine housing elevations constructed according to the principles of the disclosure.

FIG. 40 shows turbine housing lids constructed according to the principles of the disclosure.

FIG. 41 shows a turbine housing 0 ring housing constructed according to the principles of the disclosure.

FIG. 42 shows turbine i & ii plan constructed according to the principles of the disclosure.

FIG. 43 shows a turbine vertical section constructed according to the principles of the disclosure.

FIG. 44 shows a turbine top plate constructed according to the principles of the disclosure.

FIG. 45 shows a turbine vane set-out constructed according to the principles of the disclosure.

FIG. 46 shows turbine top & bottom plate plans constructed according to the principles of the disclosure.

FIG. 47 shows a generator vertical section (referenced as GR) constructed according to the principles of the disclosure.

FIG. 48 shows a generator elevation constructed according to the principles of the disclosure.

FIG. 49 shows a generator plan section constructed according to the principles of the disclosure.

FIG. 50 shows a califont plan section constructed according to the principles of the disclosure.

FIG. 51 shows an AC fan plan section constructed according to the principles of the disclosure.

FIG. 52 shows an AC condenser/evaporator plan section constructed according to the principles of the disclosure.

FIG. 53 shows an AC/califont vertical section constructed according to the principles of the disclosure.

FIG. 54 shows an AC/califont elevation constructed according to the principles of the disclosure.

FIG. 55 shows an AC damper/stepping motor #4 plan section constructed according to the principles of the disclosure.

FIG. 56 shows drive shafts constructed according to the principles of the disclosure.

FIG. 57 shows an internal suspension structure & pole (referenced as SS) constructed according to the principles of the disclosure.

FIG. 58 shows an oven & hob (referenced as HB) constructed according to the principles of the disclosure.

FIG. 59 shows a cooker solar generator constructed according to the principles of the disclosure.

FIG. 60 shows a water purifier vertical section (referenced as WP) constructed according to the principles of the disclosure.

FIG. 61 shows a water purifier plan section constructed according to the principles of the disclosure.

FIG. 62 shows a water purifier plan section still constructed according to the principles of the disclosure.

FIG. 63 shows a water purifier solar unit constructed according to the principles of the disclosure.

FIG. 64 shows a sewage treatment plant plan section STP constructed according to the principles of the disclosure.

FIG. 65 shows a sewage treatment plant vertical section constructed according to the principles of the disclosure.

FIG. 66 shows a sewage treatment section solar generator constructed according to the principles of the disclosure.

FIG. 67 shows a water heater vertical section (referenced as HWH) constructed according to the principles of the disclosure.

FIG. 68 shows a water heater plan section constructed according to the principles of the disclosure.

FIG. 69 shows a water heater solar generator section constructed according to the principles of the disclosure.

### DETAILED DESCRIPTION OF THE DISCLOSURE

The embodiments of the disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure, which is defined solely by the appended claims and applicable law. Moreover, it is noted that like reference numerals represent similar parts throughout the several views of the drawings.

The solar unit of the invention produces energy by using heat from the sun instead of light so that it will operate 24 hours a day. It does not function by converting energy from light the way a photovoltaic cell converts light to electricity. The solar unit of the invention may:

1. Produce AC electricity which is also convertible to DC electricity;

2. Produce hot and cold air for air conditioning;

3. Produce hot water for domestic consumption;

4. Break down raw sewage;

5. Purify water to make it potable; and

6. Produce heat for cooking.

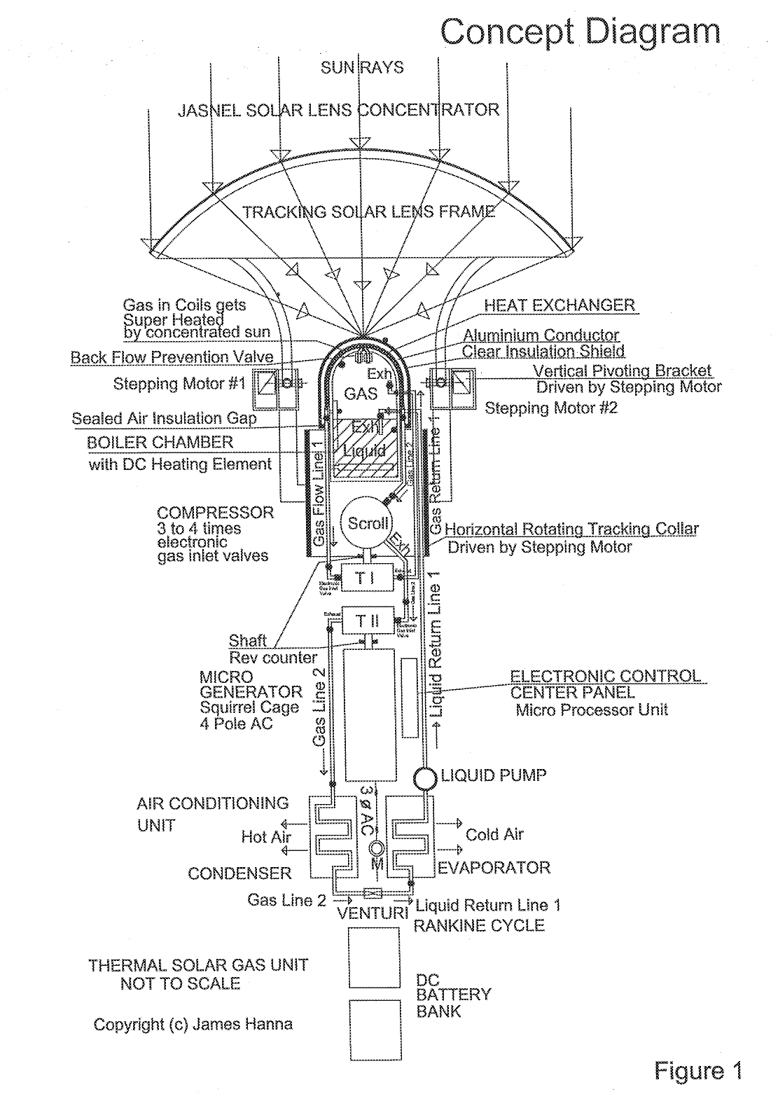

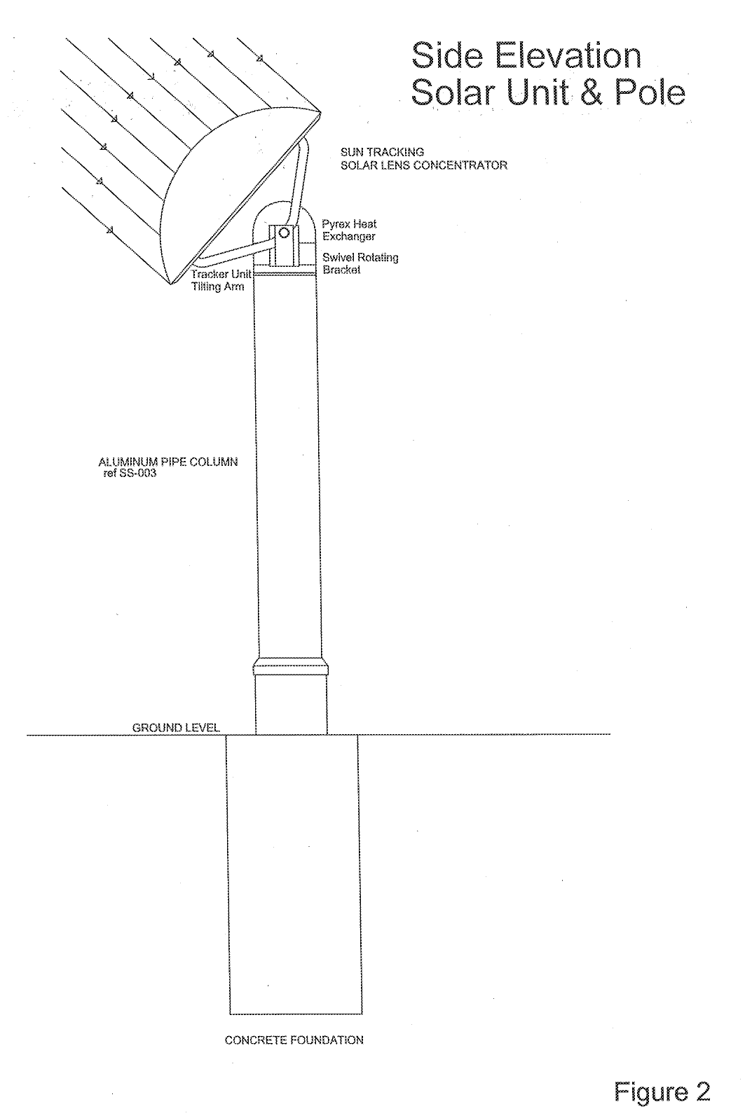

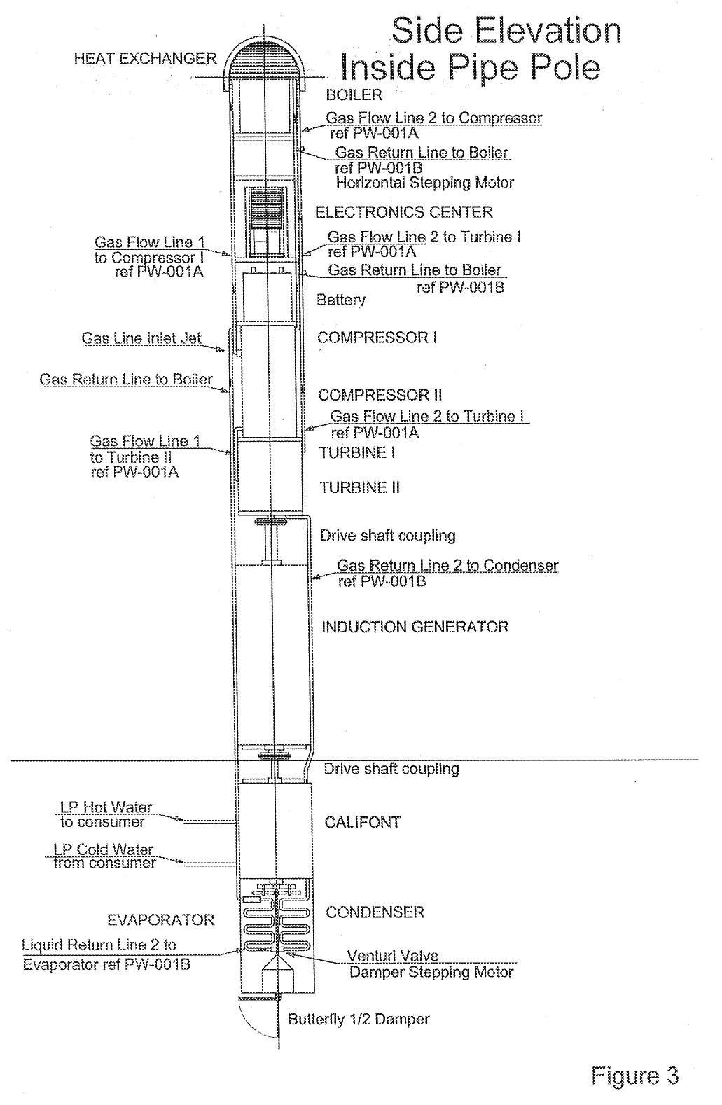

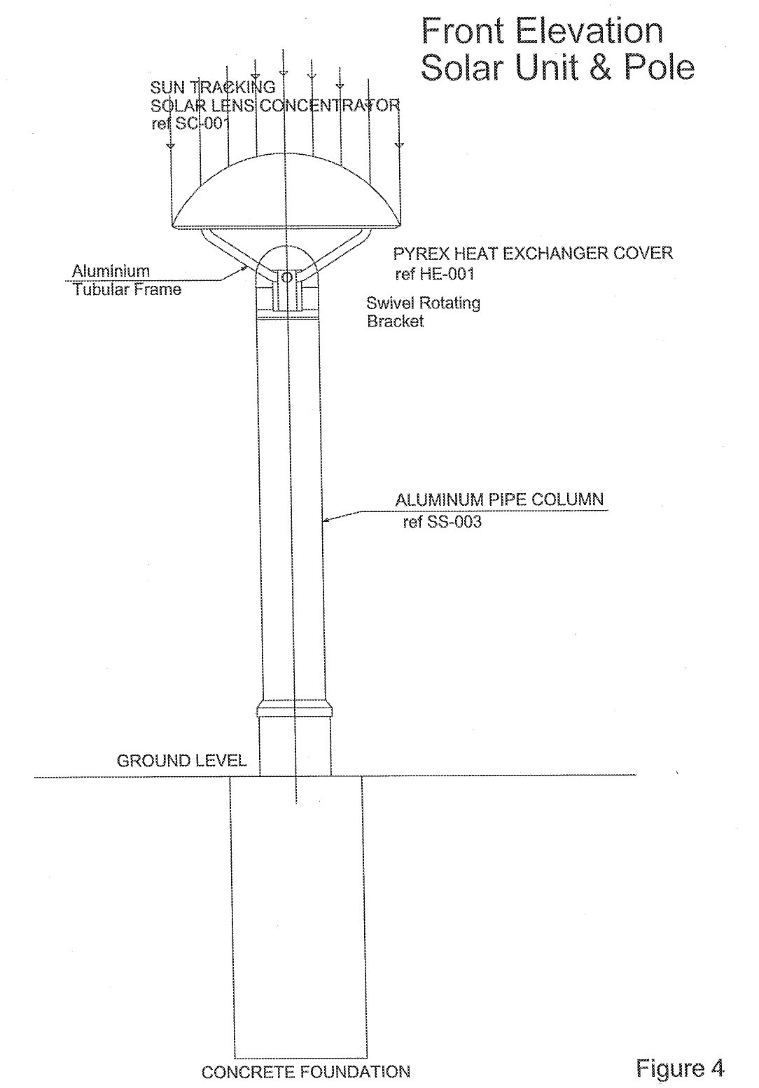

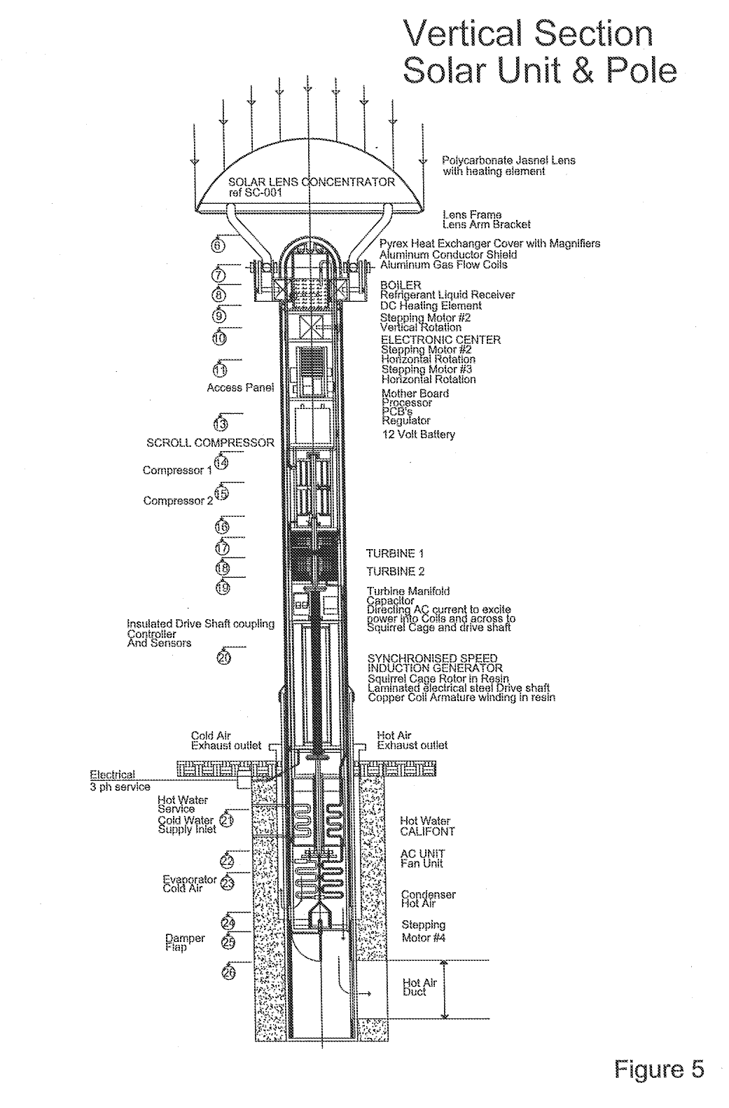

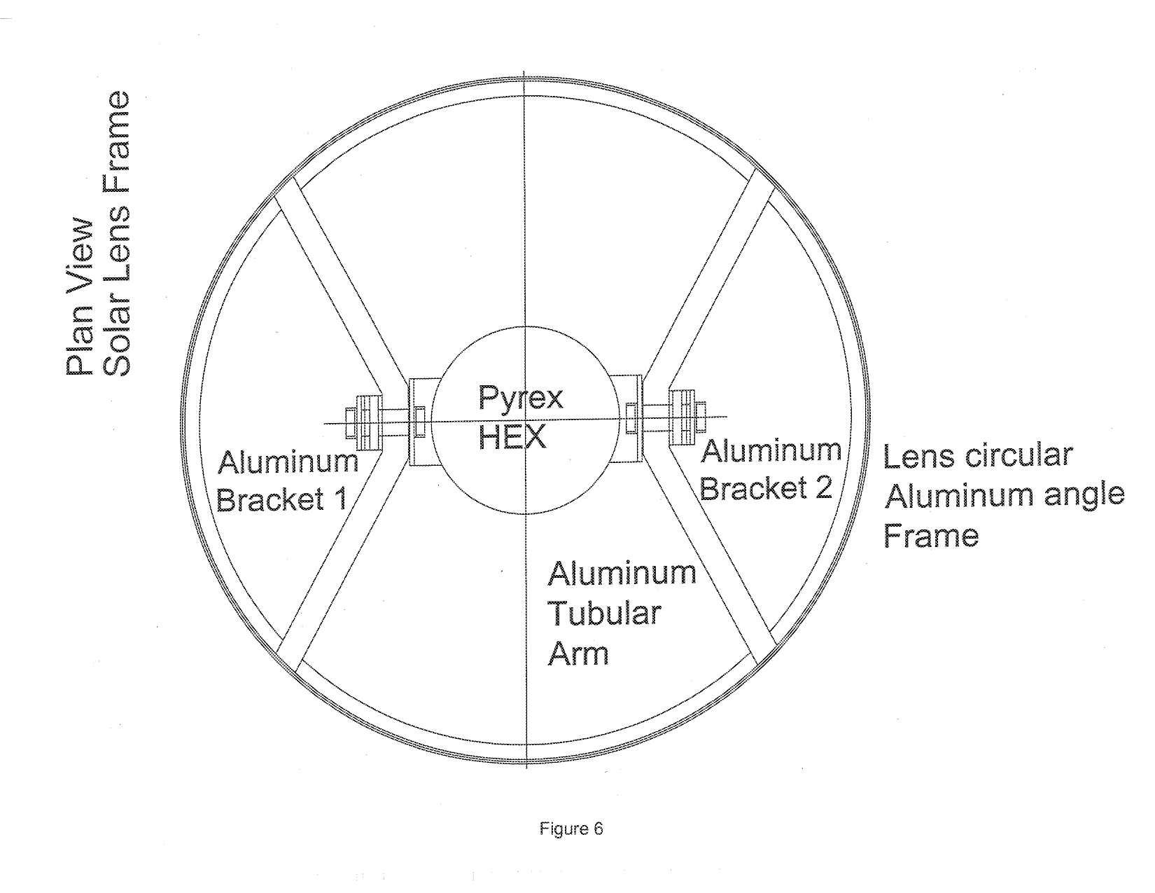

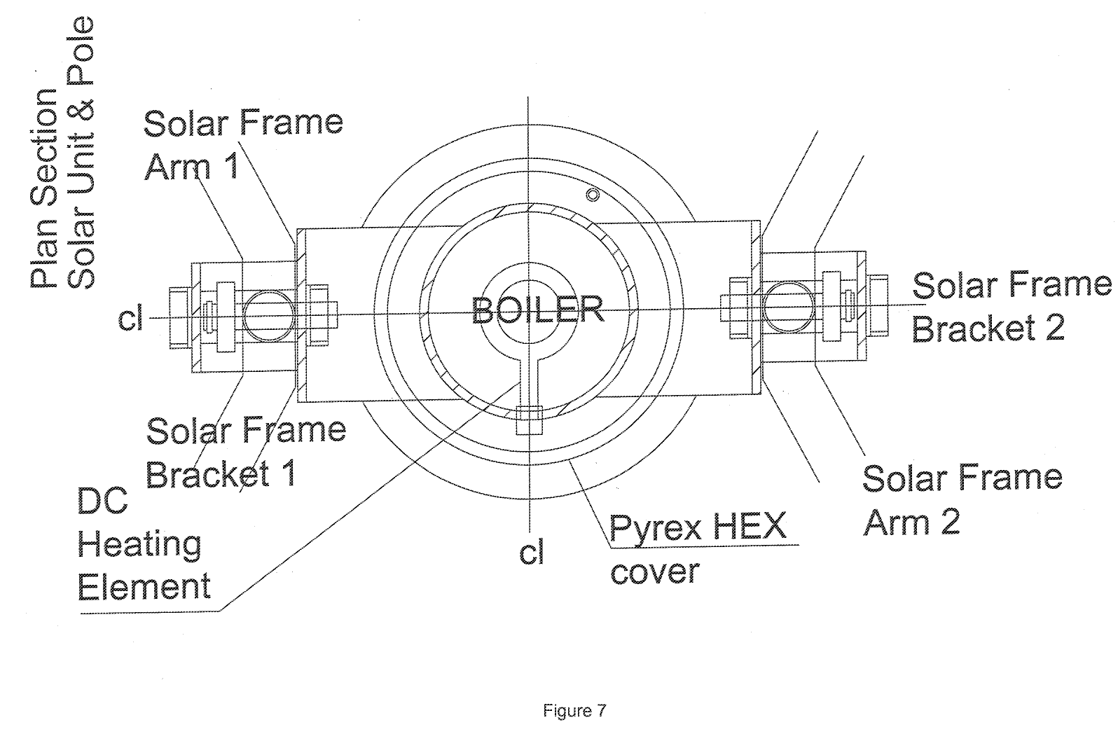

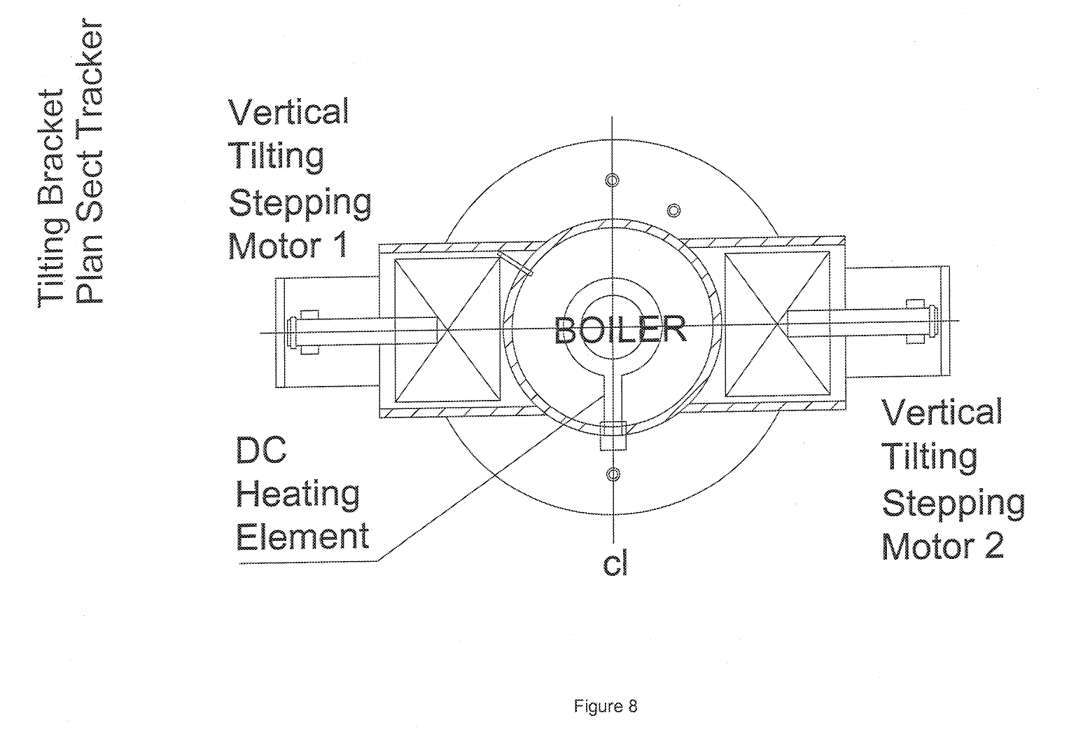

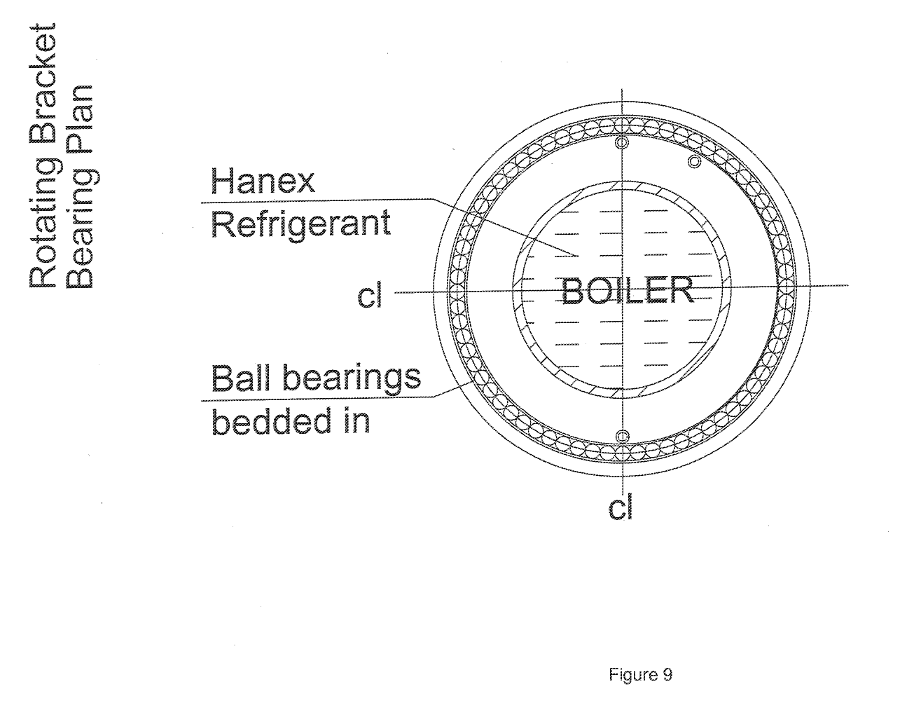

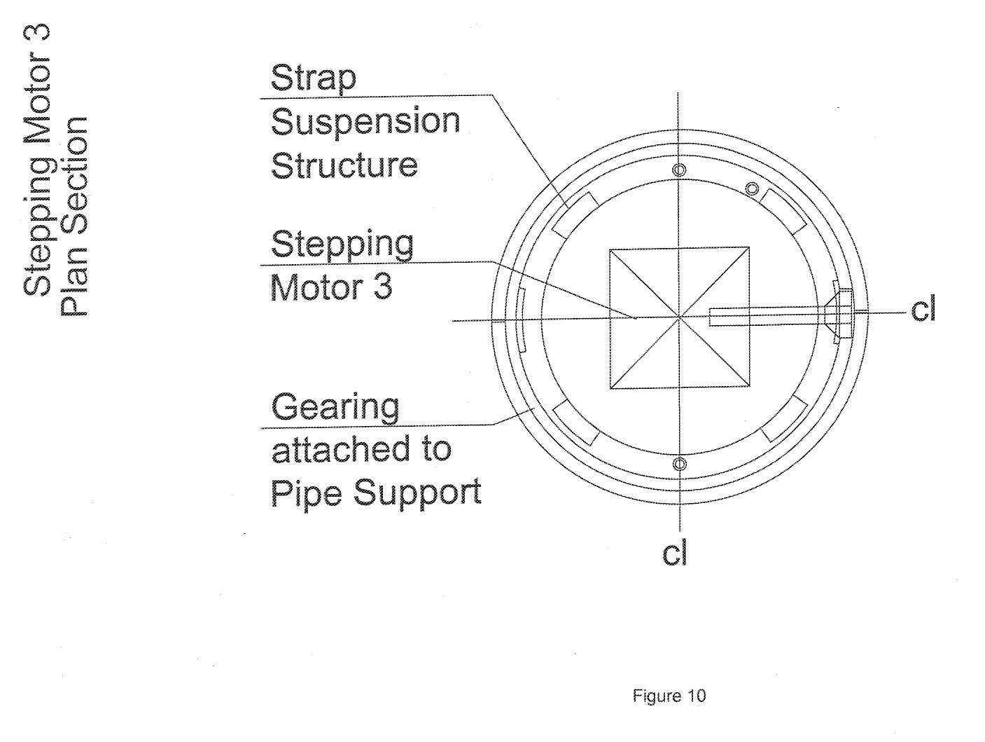

FIG. 1 shows a solar energy system constructed according to the principles of the disclosure. As shown in FIG. 1, each solar unit may include a circular sun tracking lens which may be swivel mounted. In particular, the lens may be mounted on a lightweight frame, such as an aluminum frame as shown in FIG. 4. The circular sun tracking lens may in some aspects be approximately 3′ 3″ in diameter. However any shape or diameter is within the scope and spirit of the invention. Additionally, the circular sun tracking lens may be a Fresnel lens. The Fresnel lens may be a concave Fresnel lens to make focal lengths of light rays all the same to shorten wave length and improve heat qualities.

This lens may move horizontally and vertically in an arc tracking the sun so that at all times it may be at an approximately right angle to the sun's rays as shown in FIG. 1. The concentrated light from the lens may be focused on a center point of a heat exchanger mounted on the top of a support. The support in some aspects may be approximately a 10″ diameter pole extending about 8′ 0″ above the ground. However, any shape, diameter or size support is within the scope and spirit of the invention. This pole may contain solar turbines, a power generating unit and associated components such as an electronic operating system.

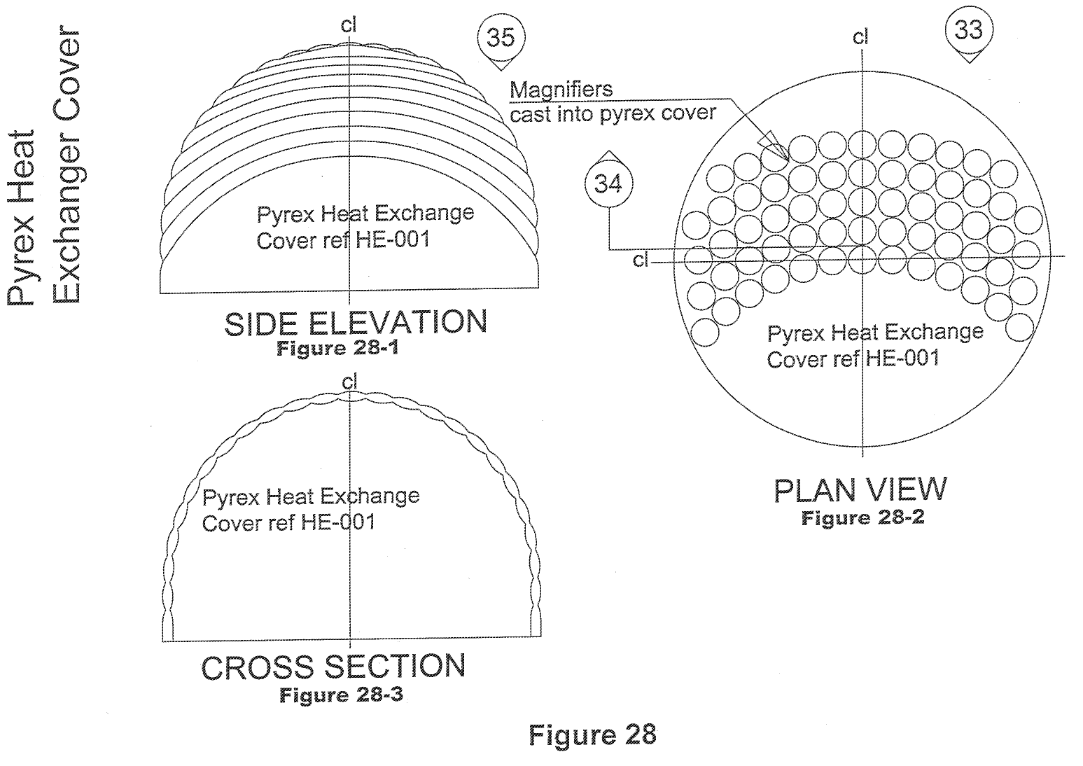

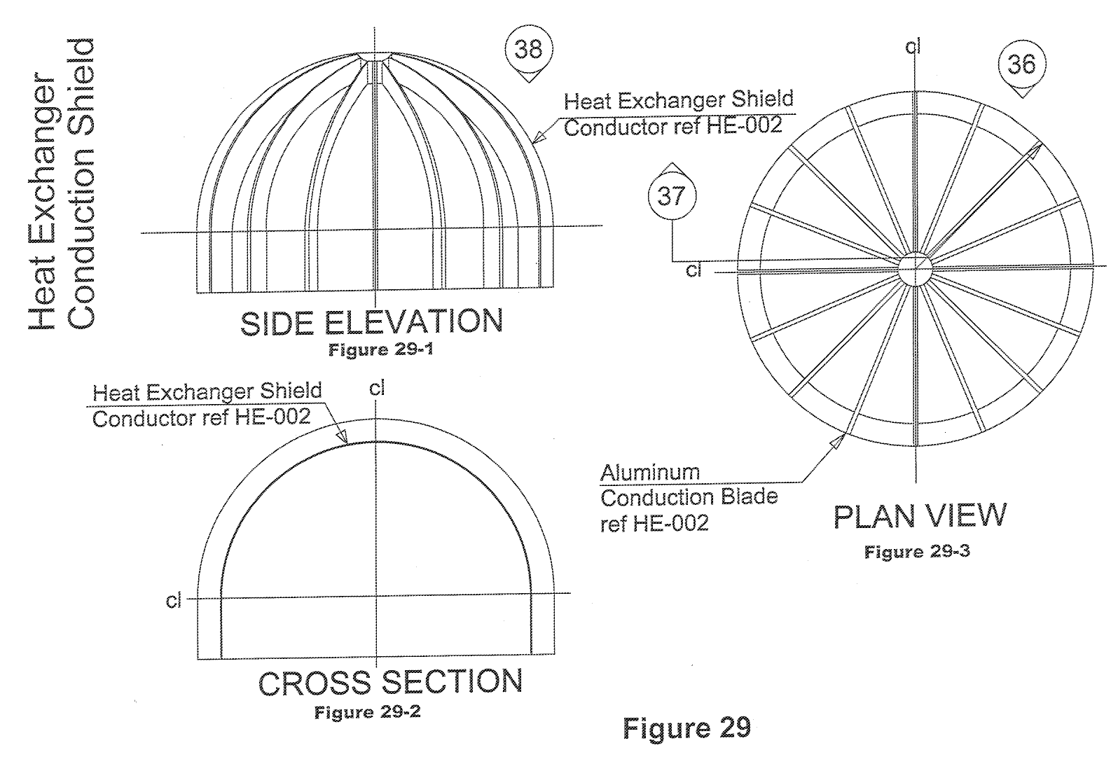

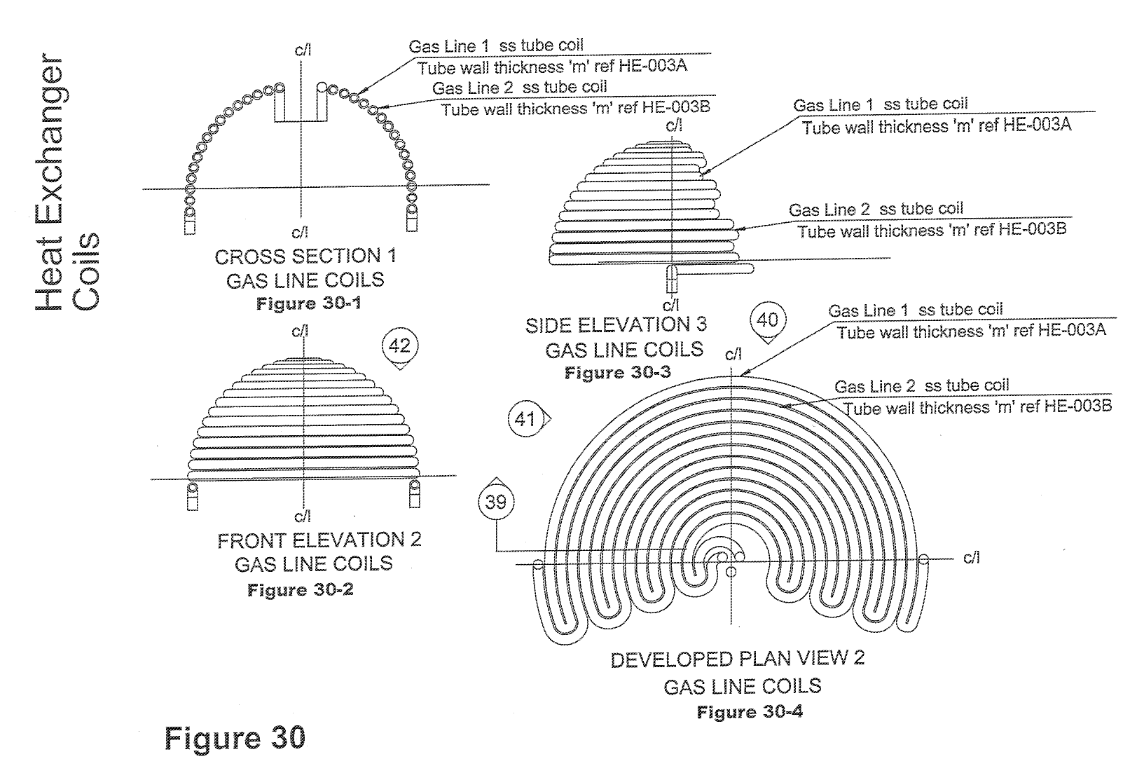

FIG. 28 shows a heat exchanger cover, shield and coils constructed according to the principles of the disclosure. Light rays from the sun fall on the Fresnel lens and may concentrate the rays onto a clear Pyrex or plastic dome shape heat exchanger cover that is shown in the Figure. This lens has cast into it small magnifiers which further concentrate the light.

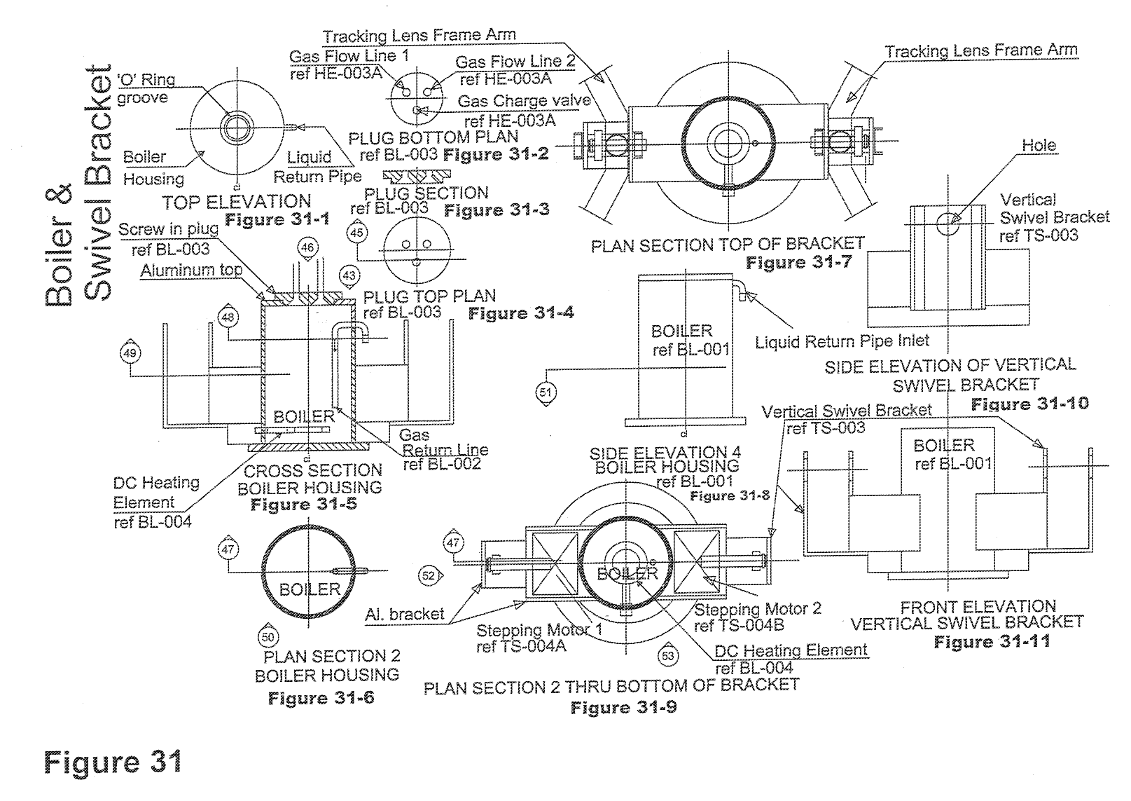

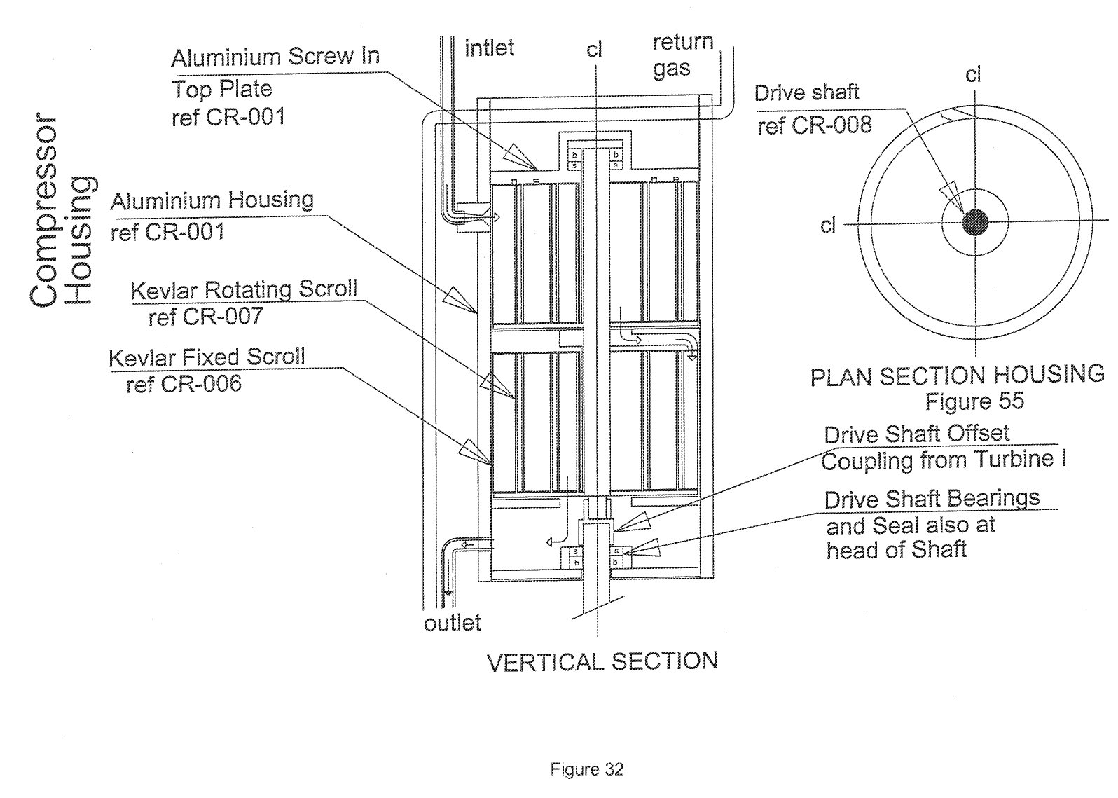

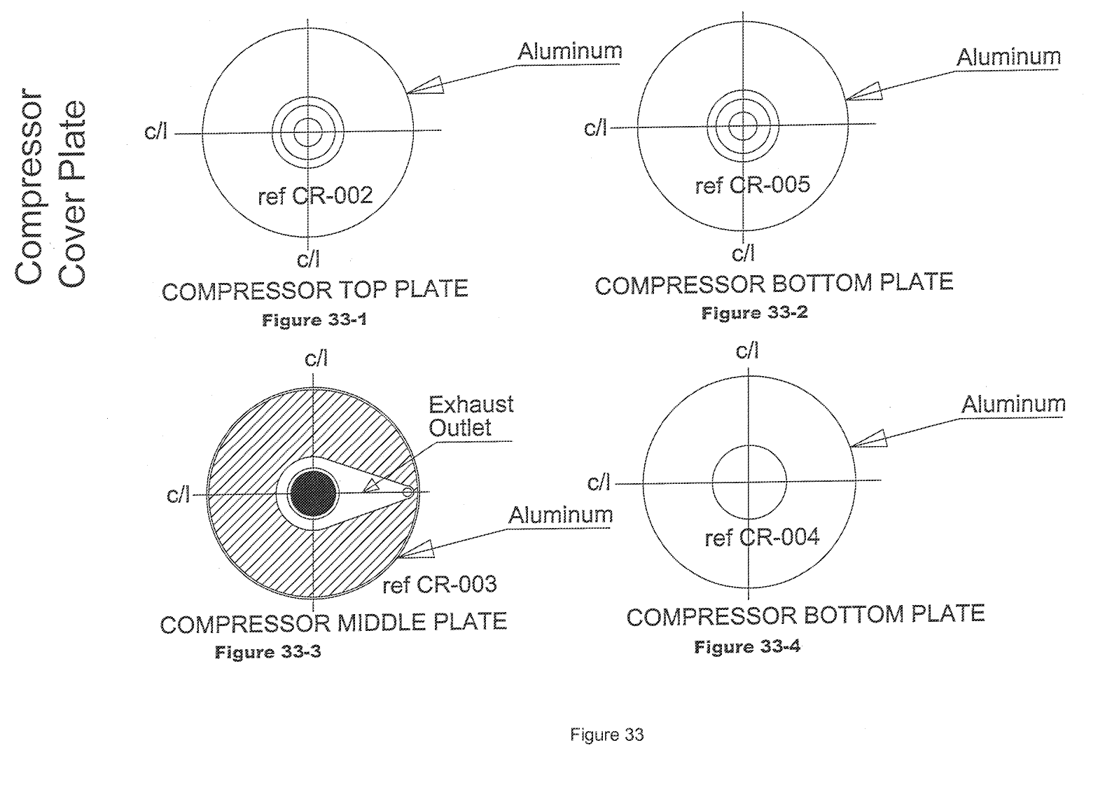

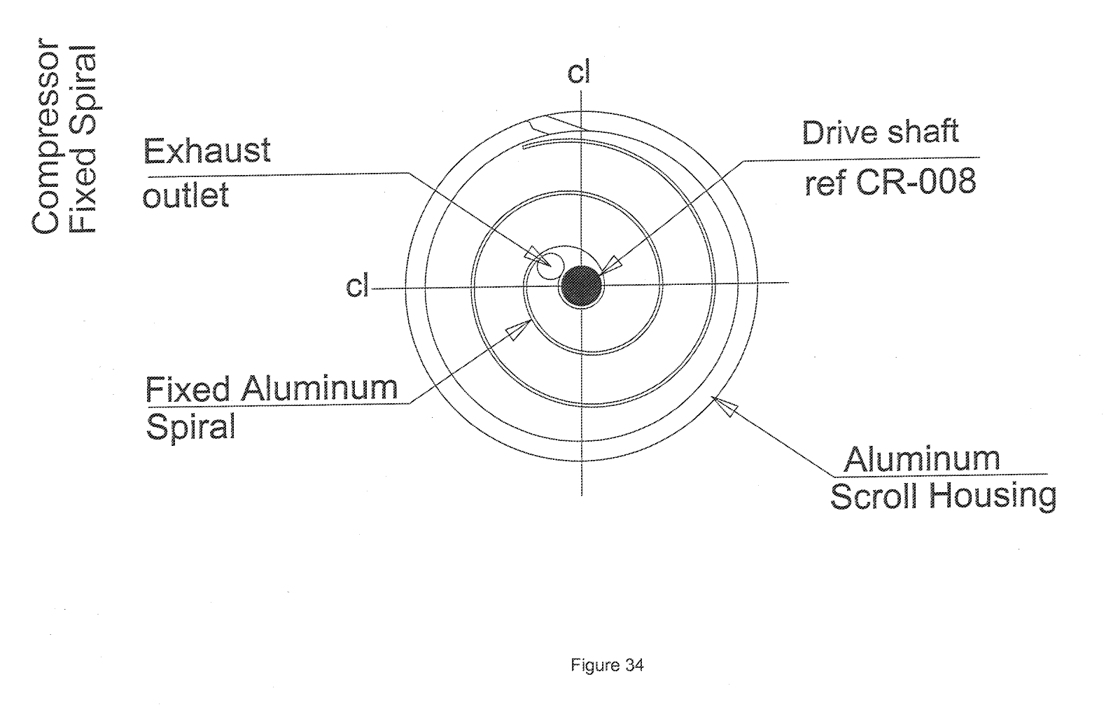

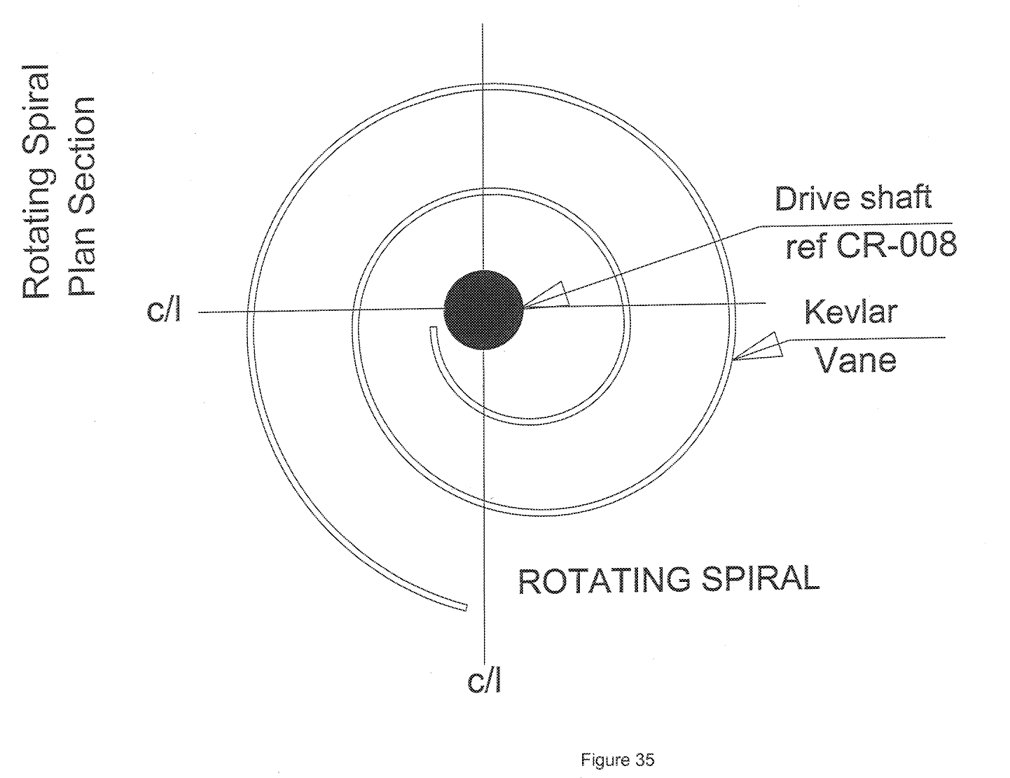

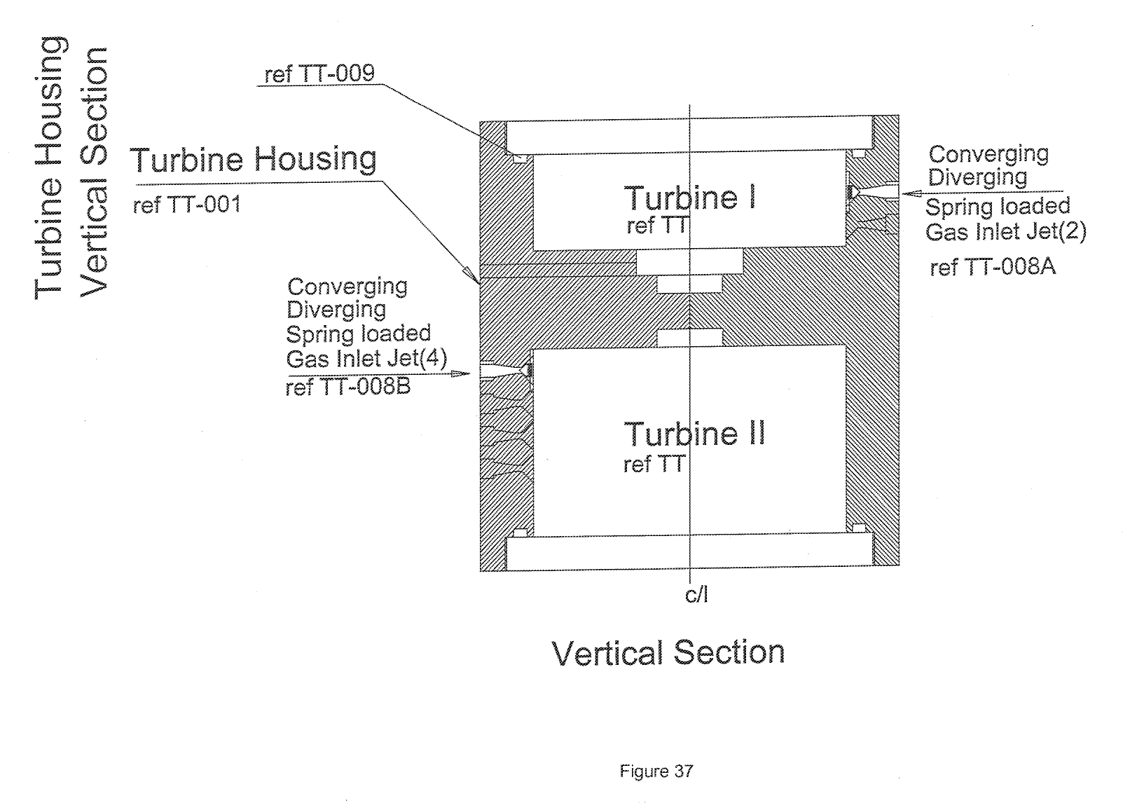

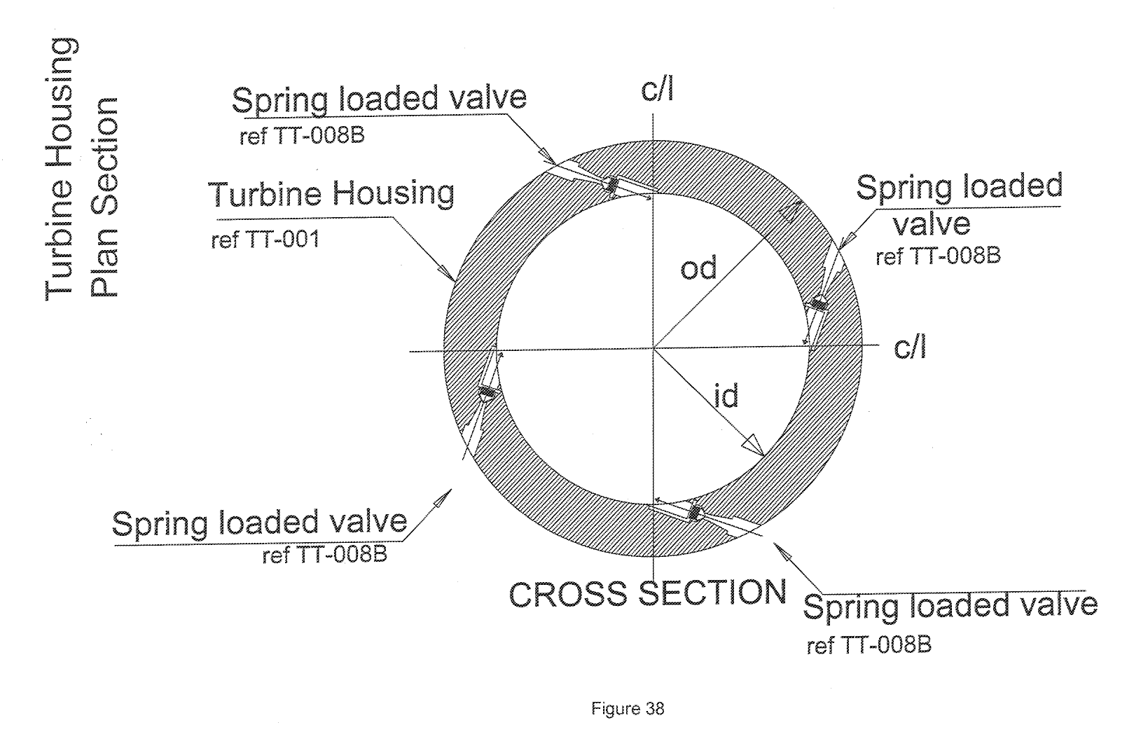

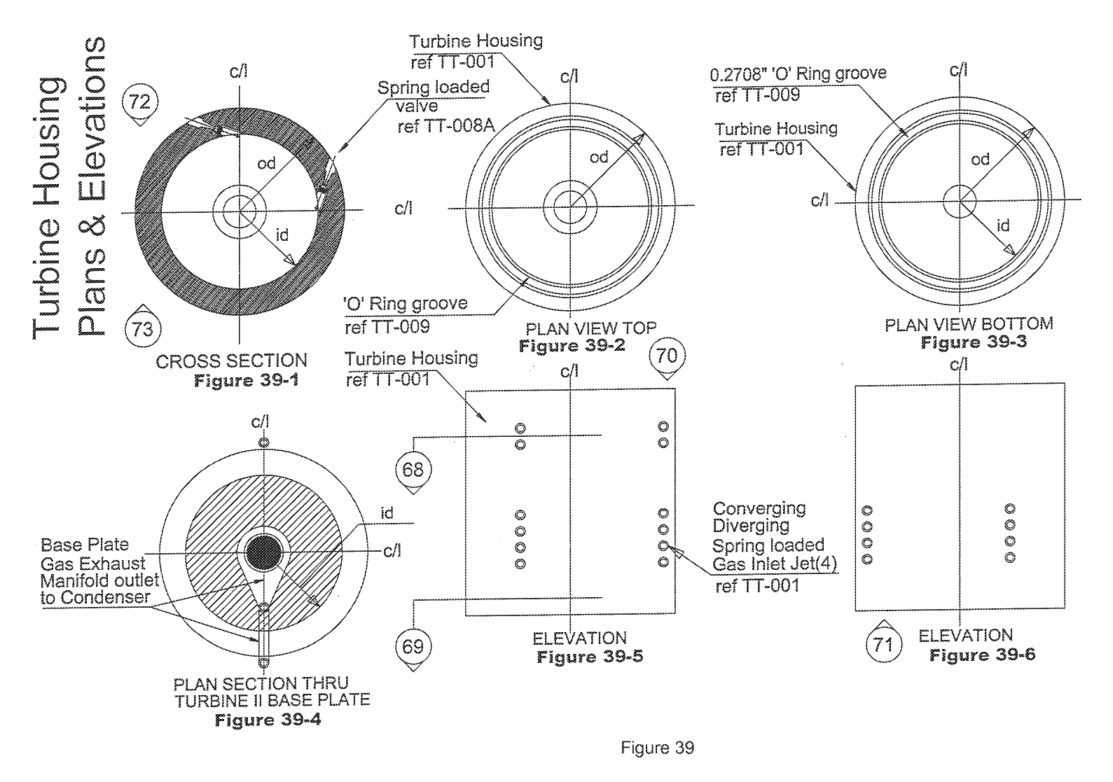

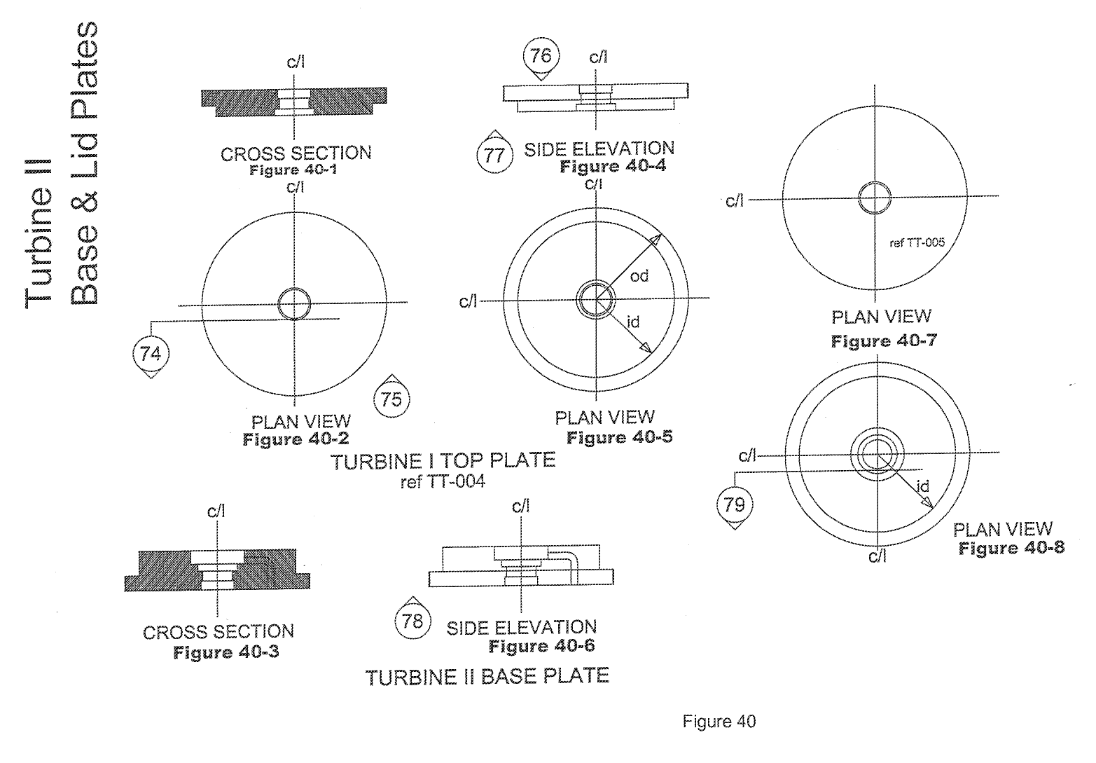

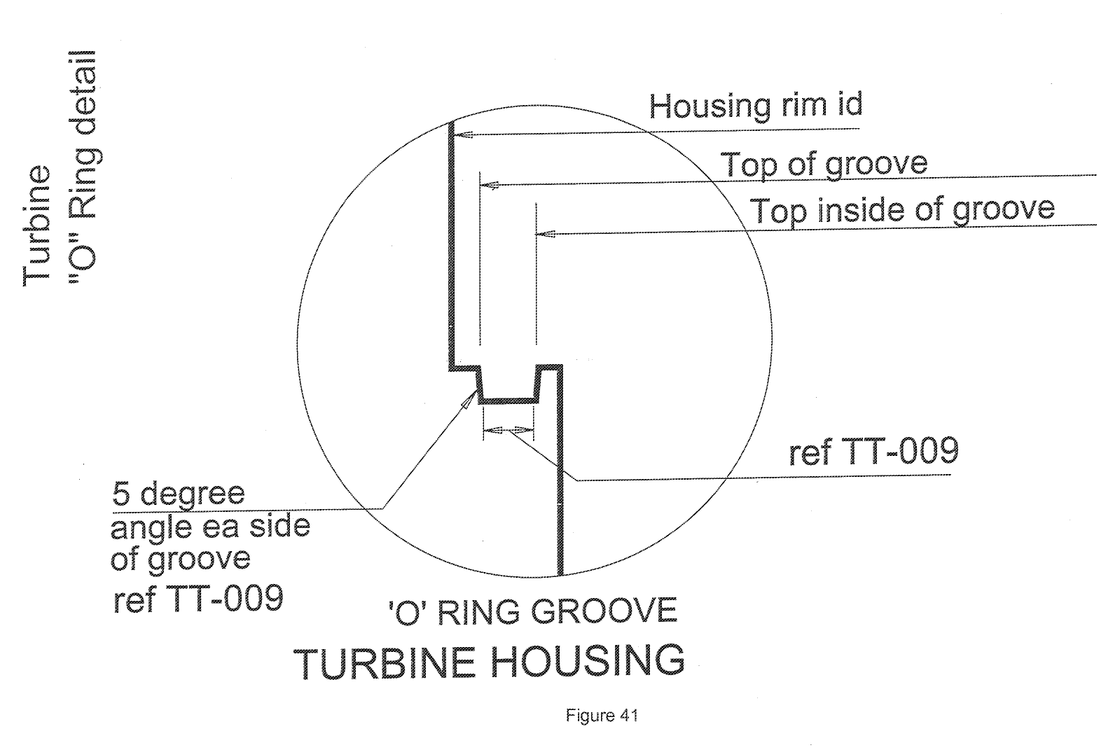

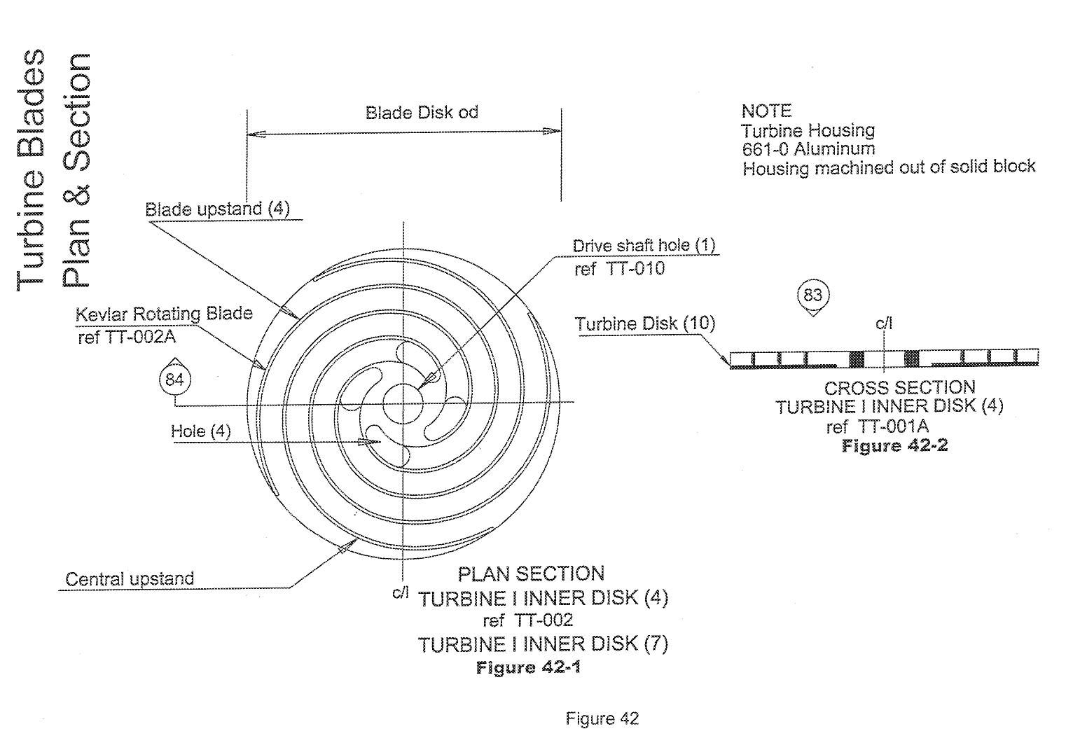

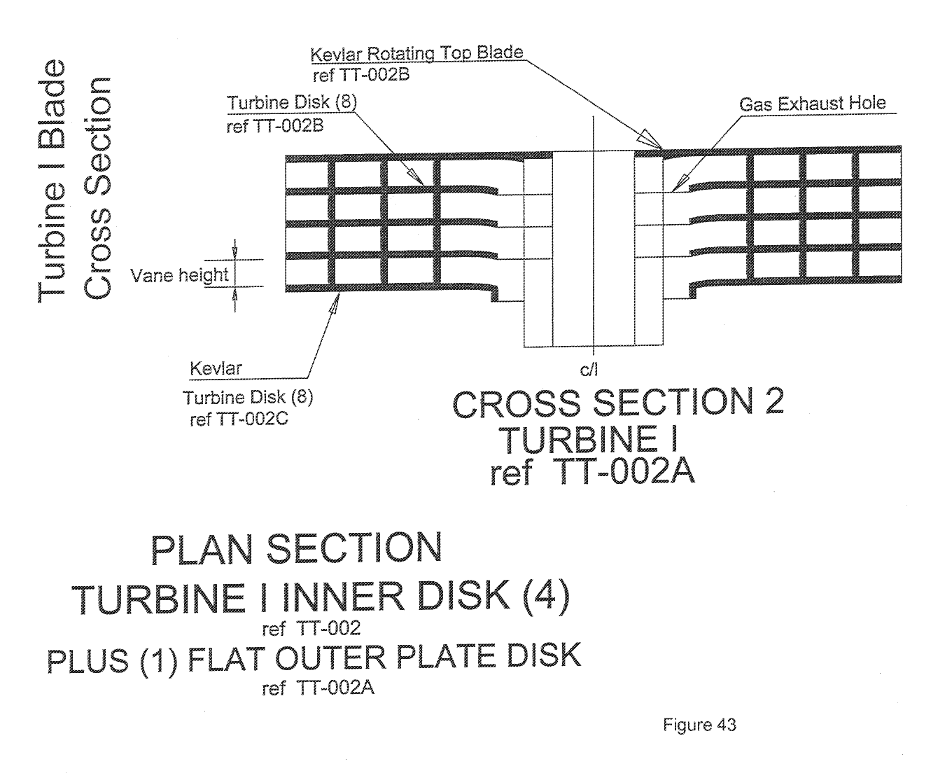

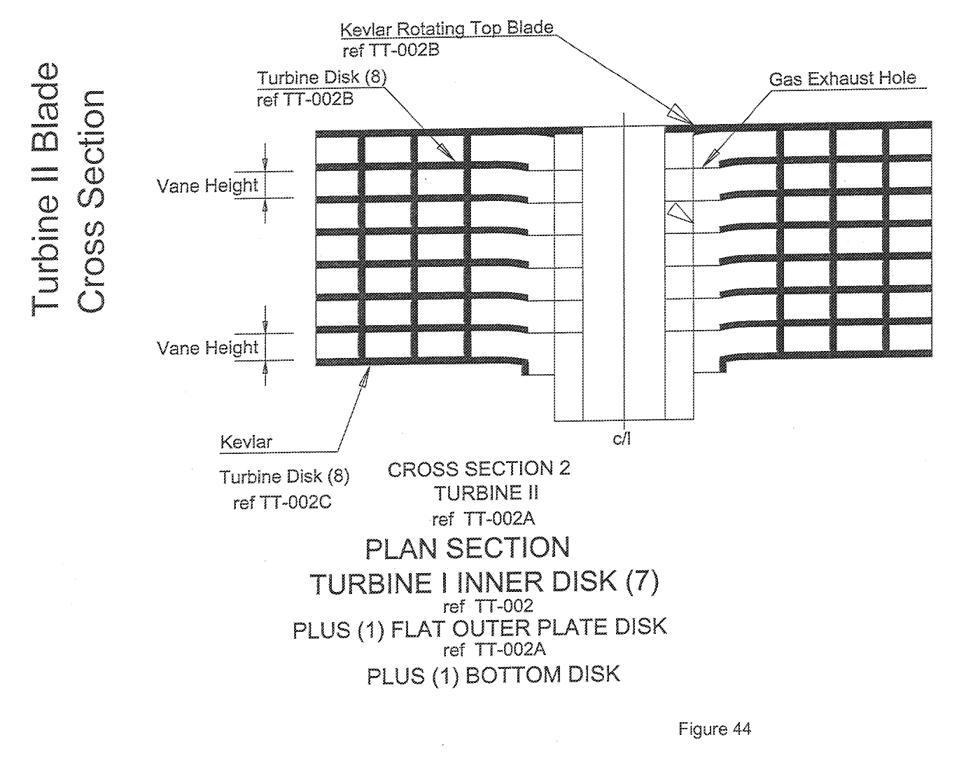

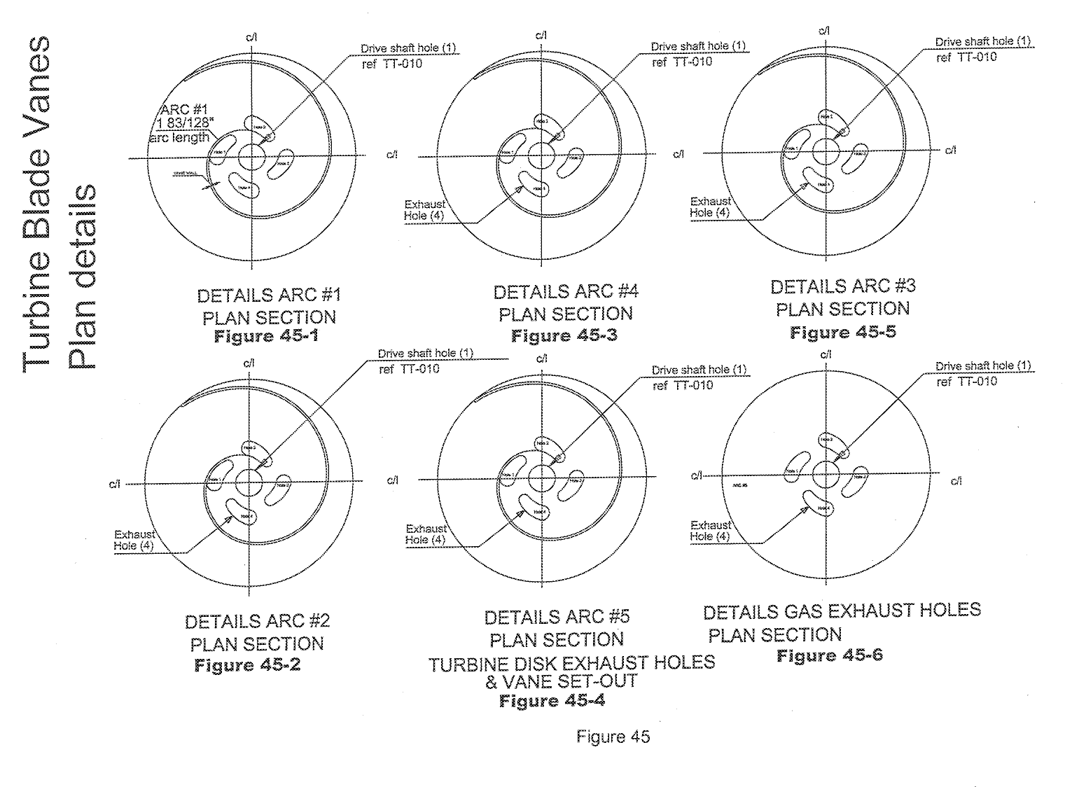

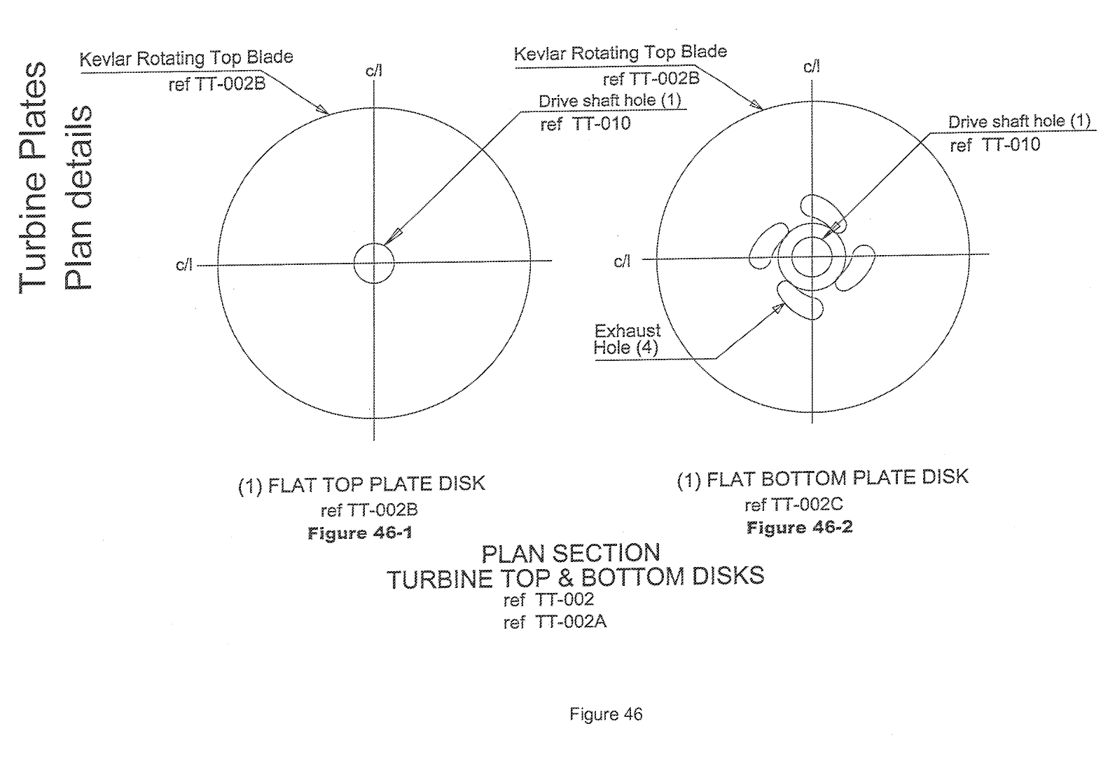

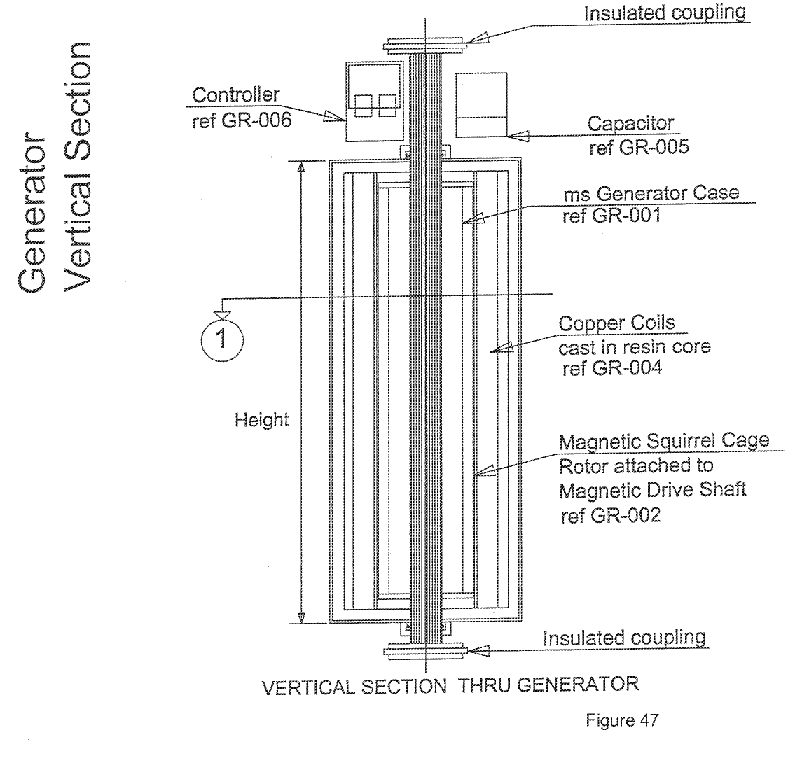

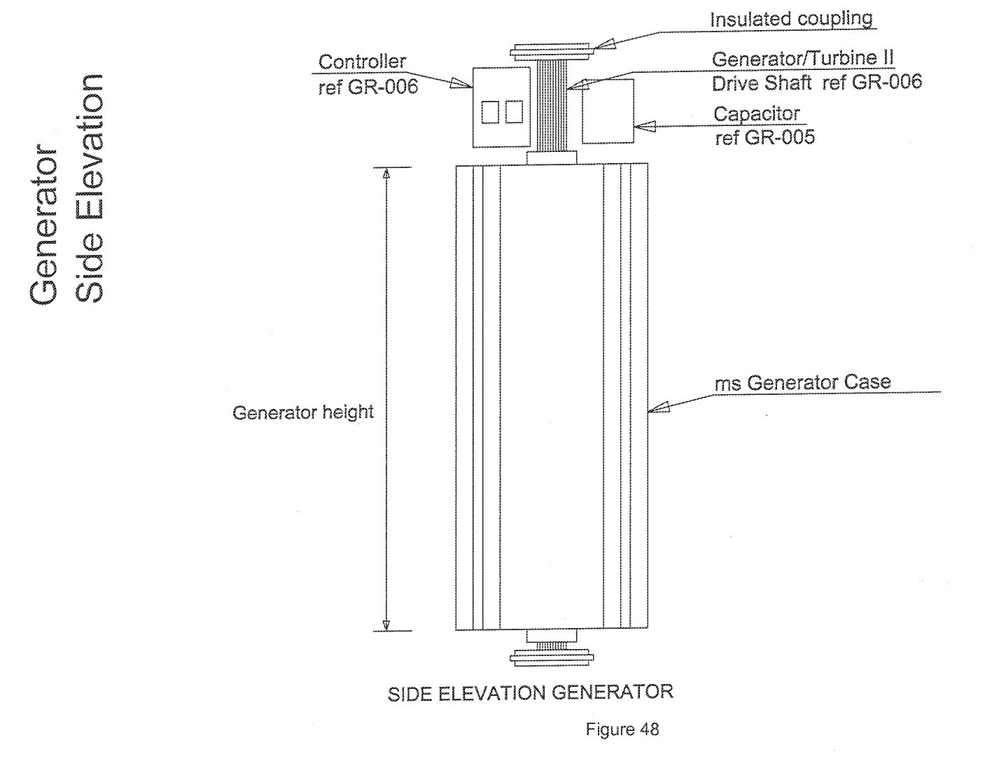

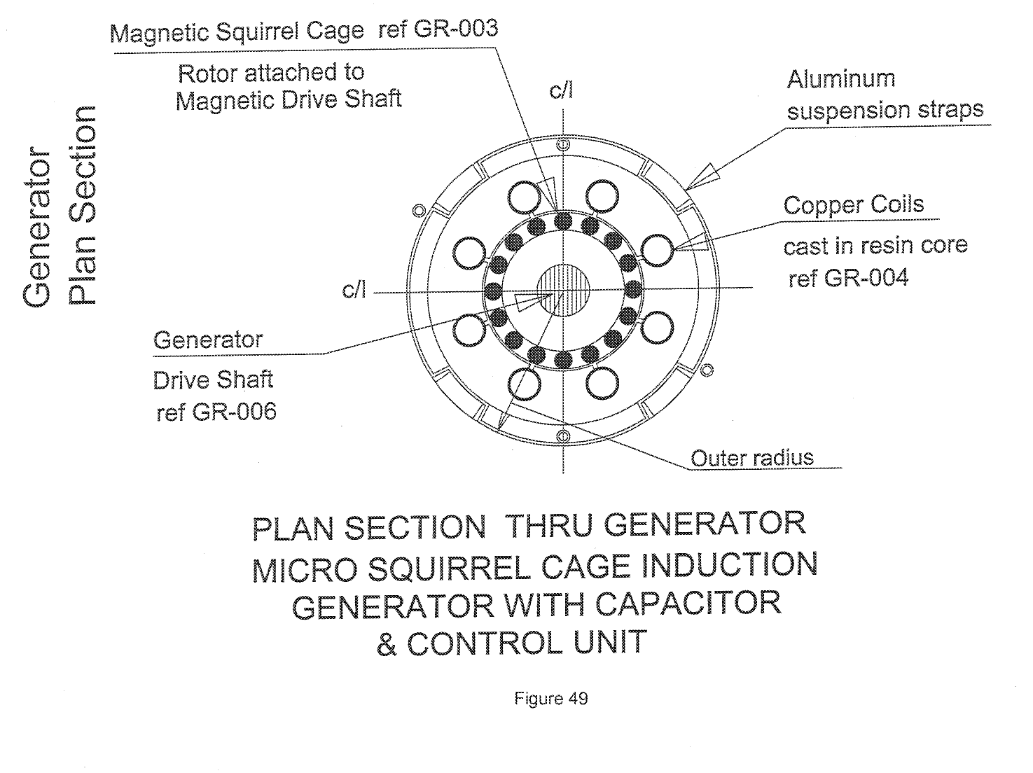

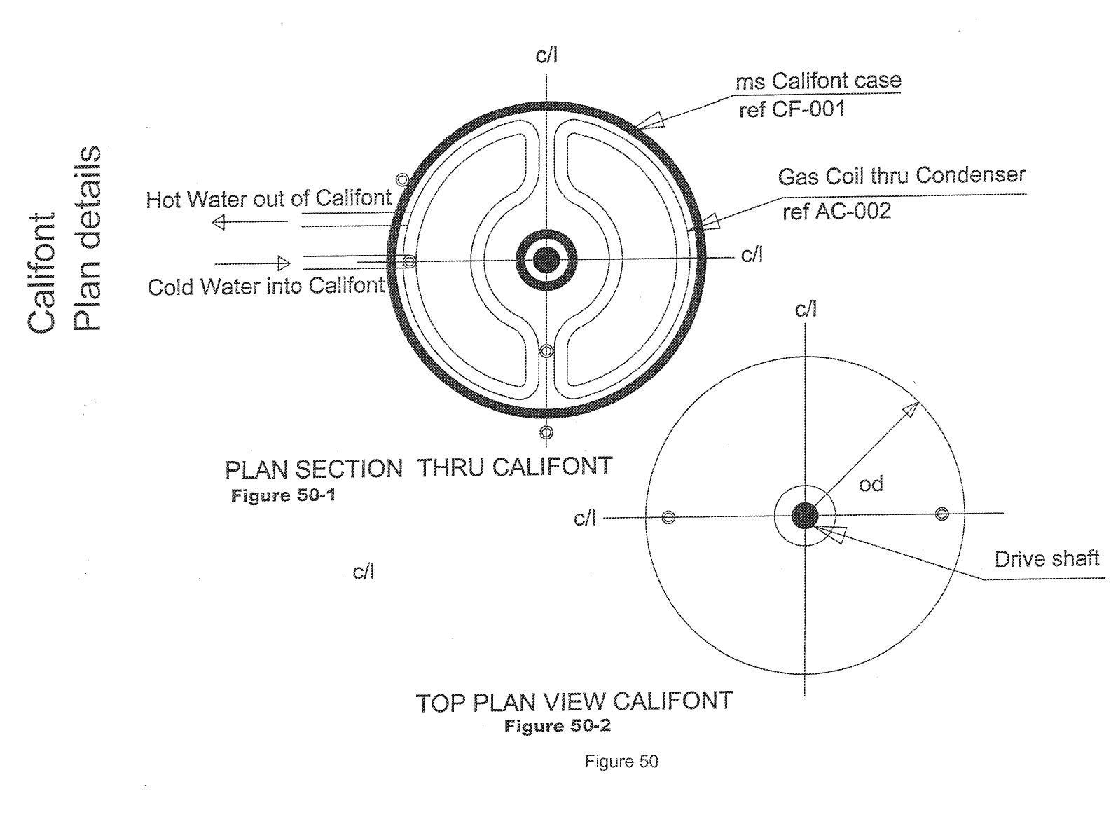

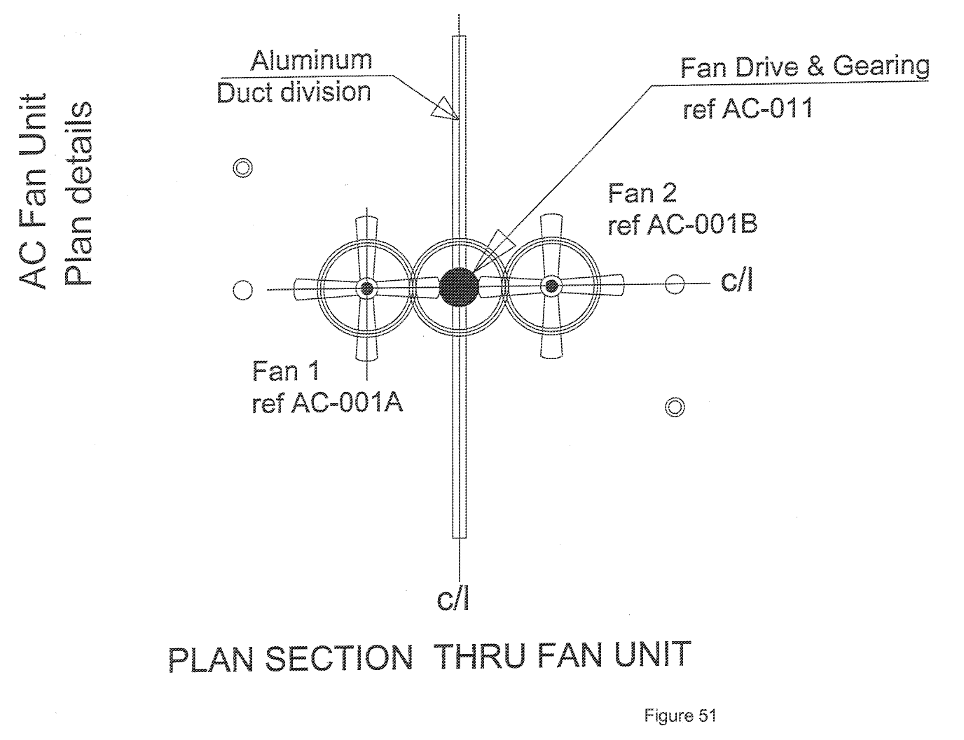

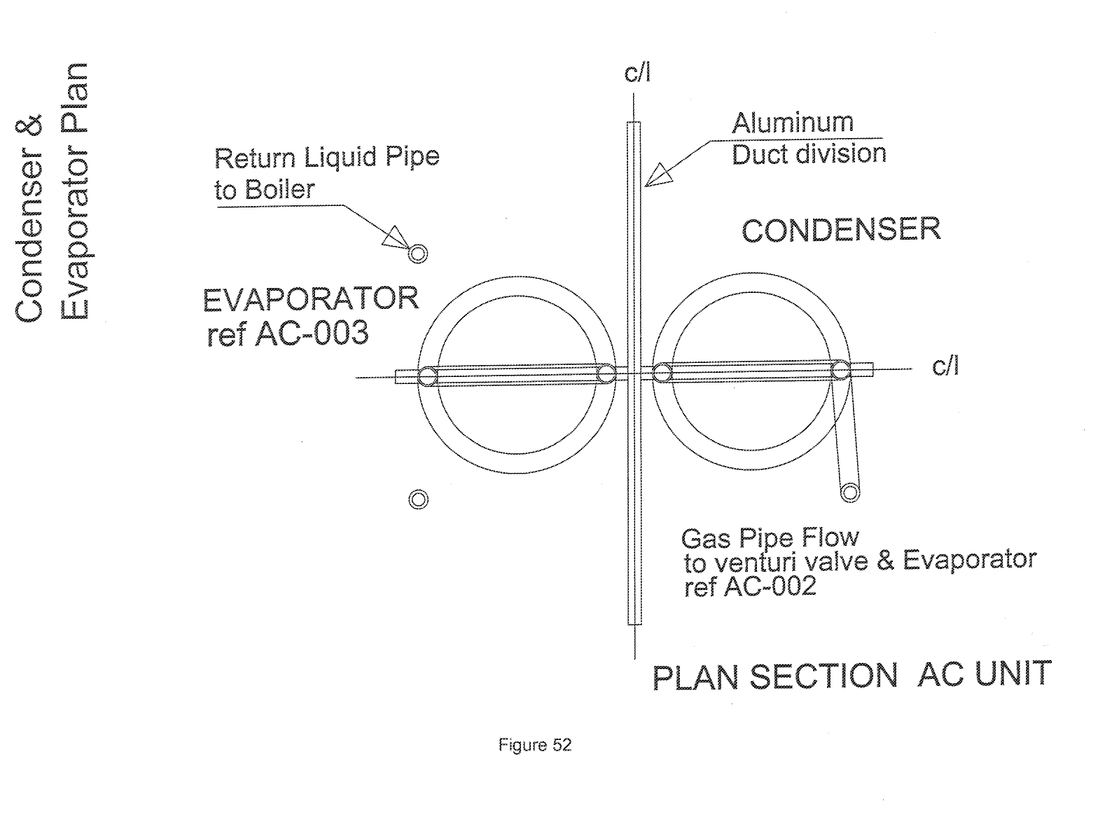

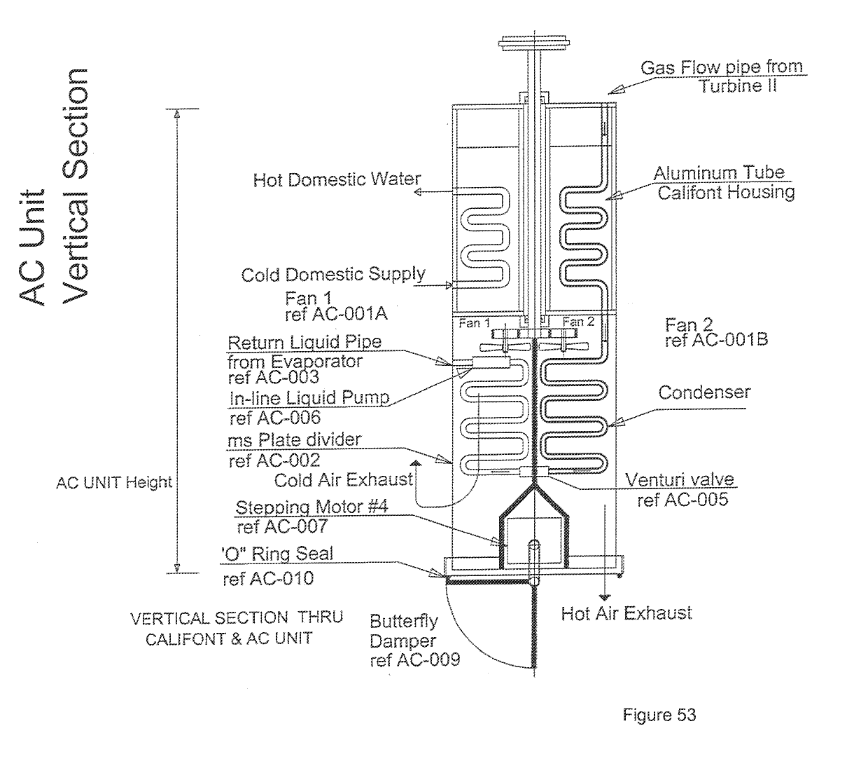

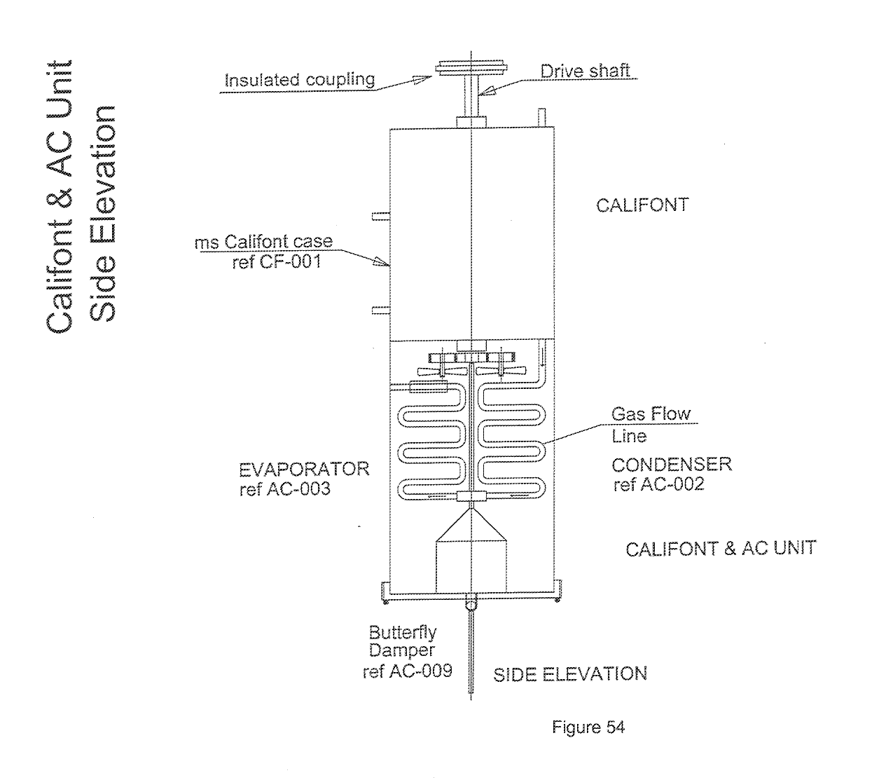

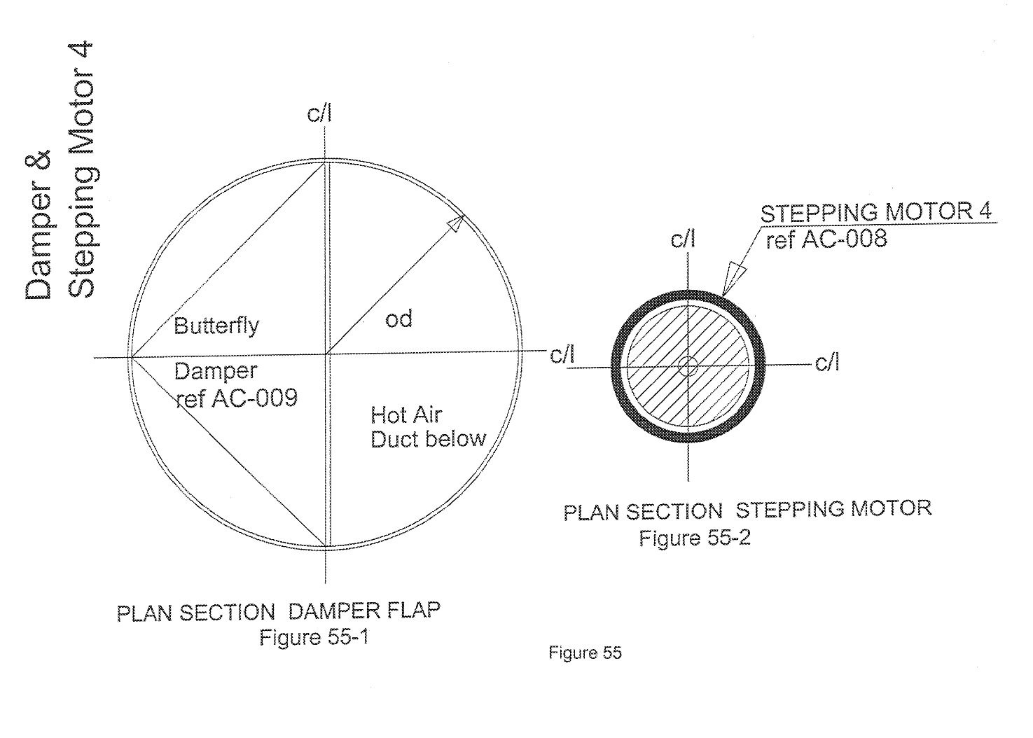

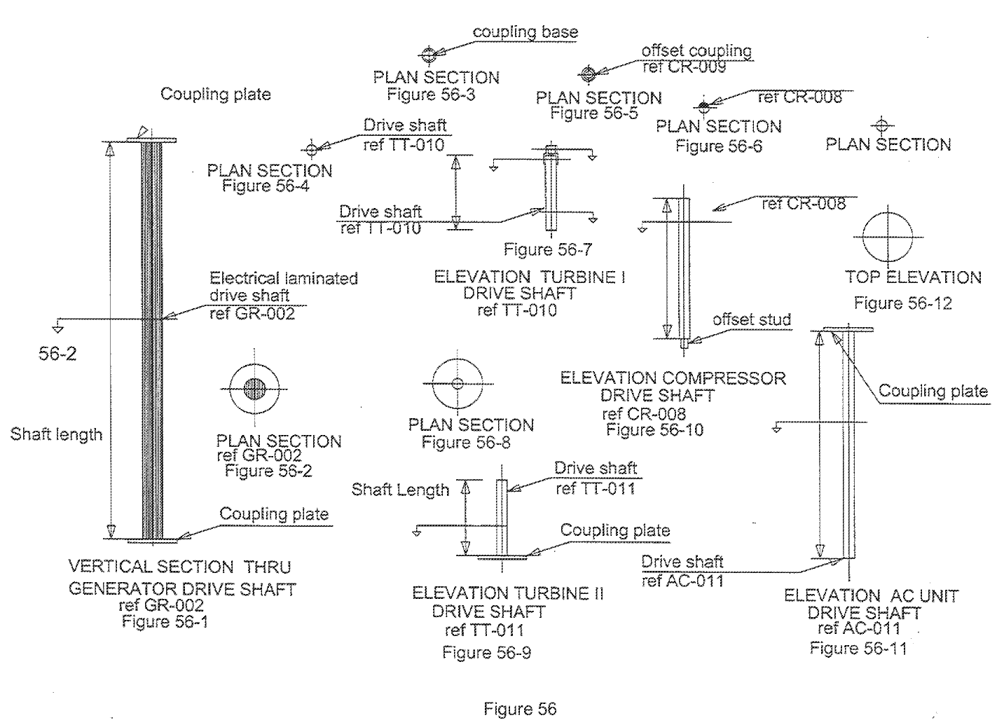

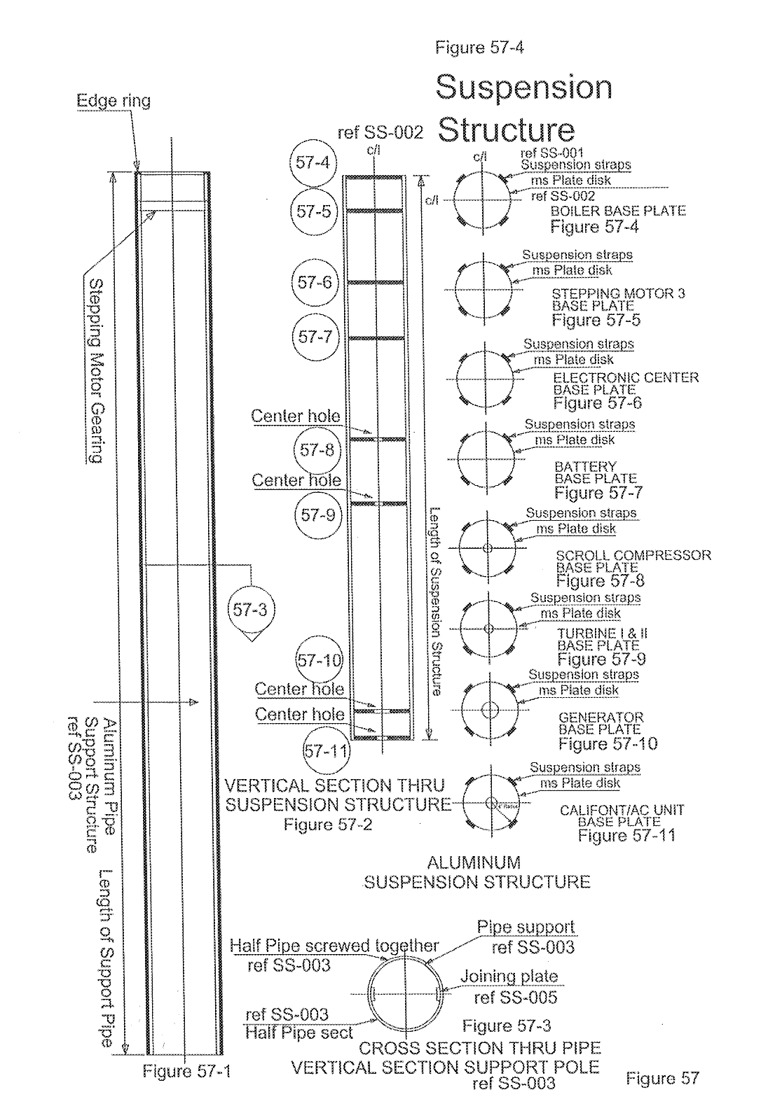

FIG. 31 shows a boiler and lens swivel bracket constructed according to the principles of the disclosure. The heat exchanger may be attached to a boiler. The boiler may contain a hanex liquid which is a refrigerant similar to that found in various types of Freon gases (similar to DuPont RC-410A Freon but boils at a lower temperature and liquefies at a higher temperature). The hanex liquid is designed to boil at a low temperature but not lower than minus 50 degrees F. When the hanex liquid boils it gives off gas. With reference to FIG. 1, this gas rises from the boiler and passes into two heat exchanger coils mounted on a conductor shield under the heat exchanger cover. The concentrated light from the lens super heats the gas while it is in the coils causing it to expand. When expanded, the gas in coil 1 will flow to compressor turbine I, then the gas will enter coil 2, and finally the gas will flow through the compressor unit on route to turbine II (the power generator).

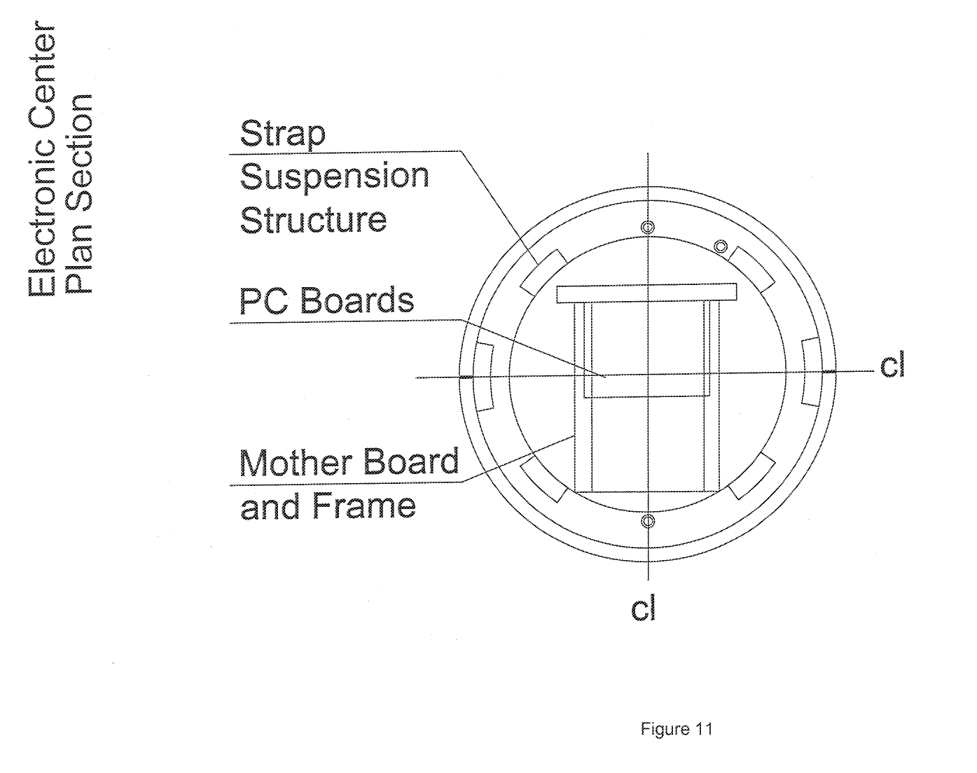

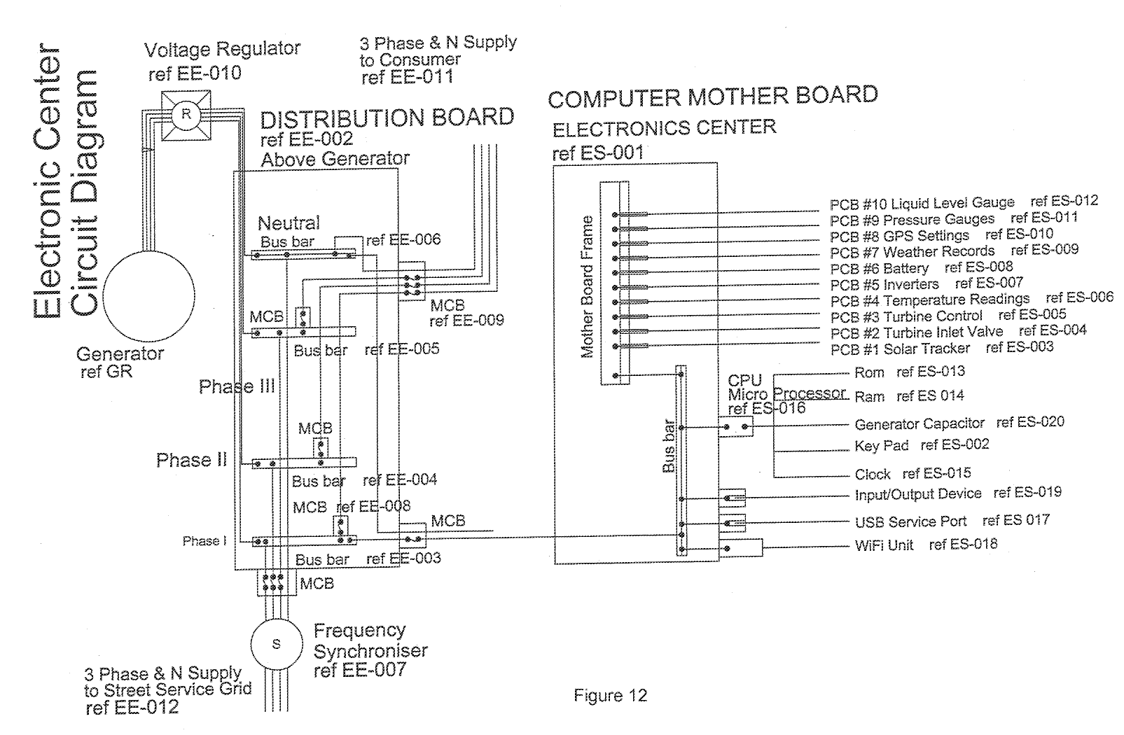

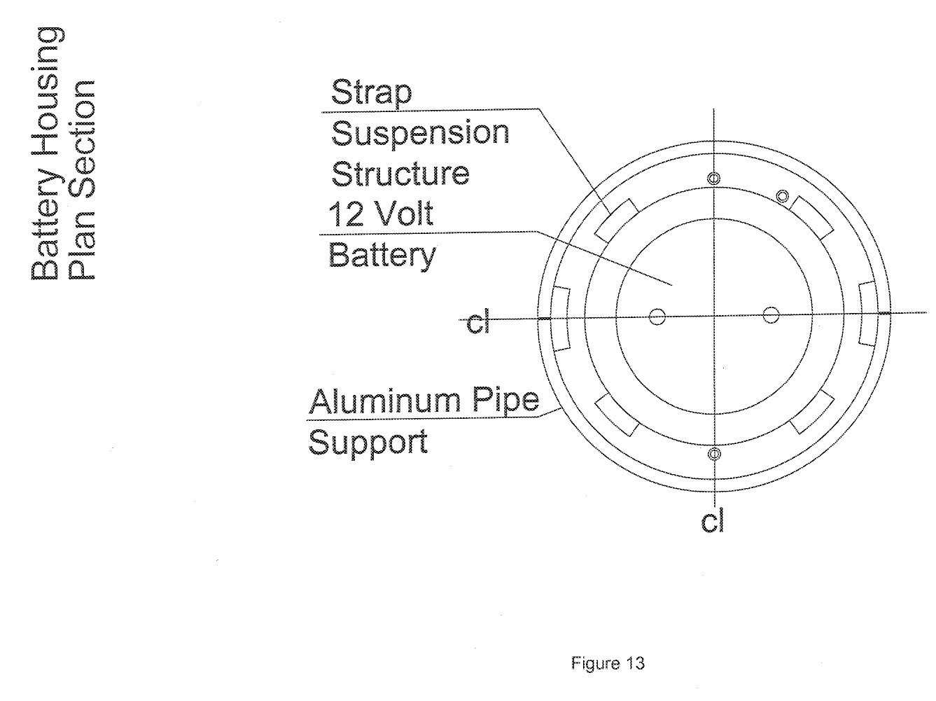

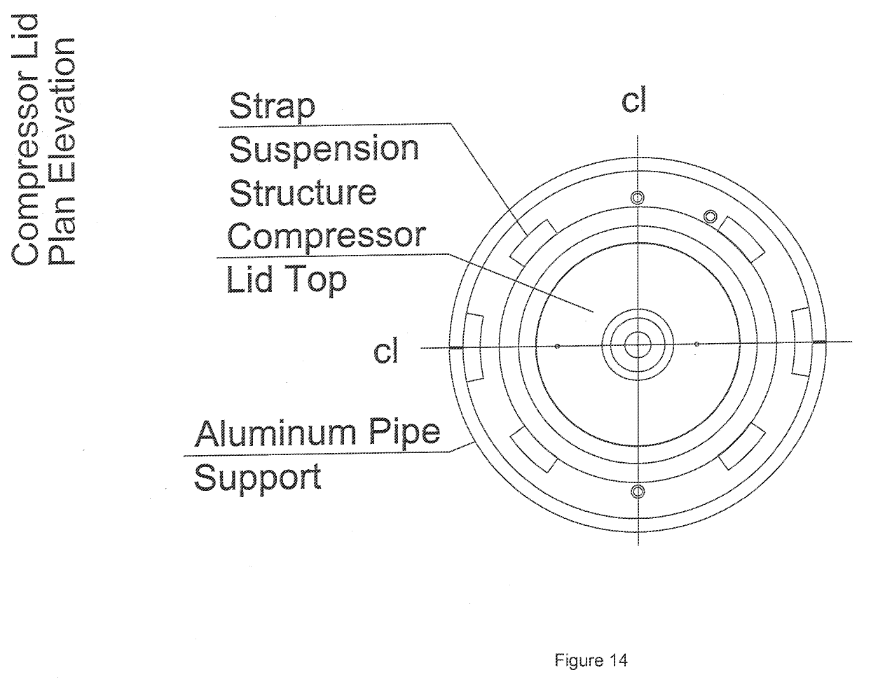

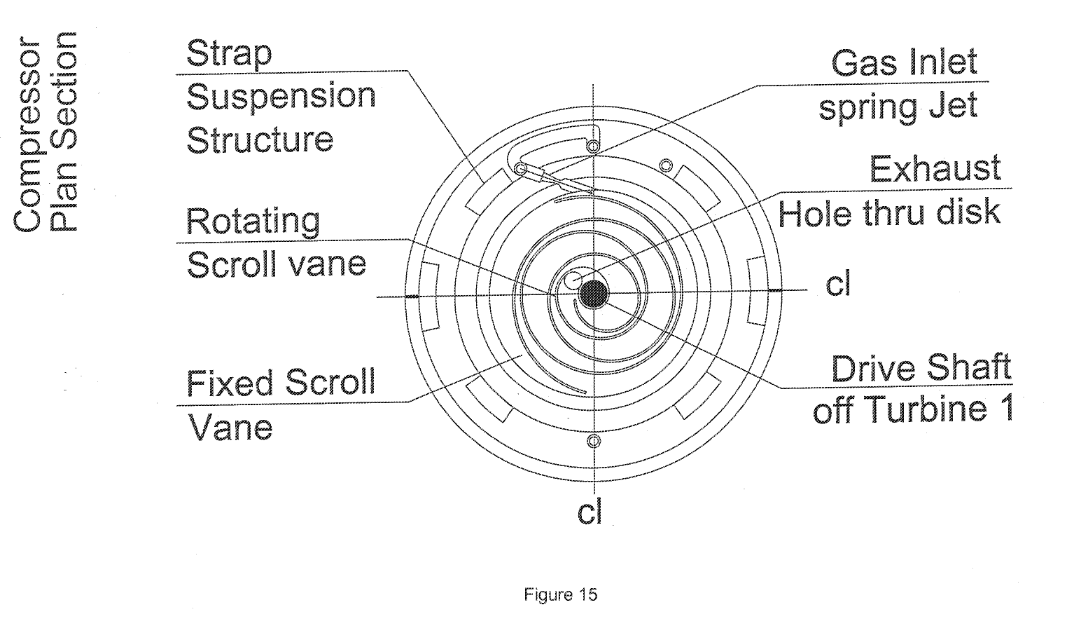

FIGS. 11 and 12 show an electronic control center and circuit diagram constructed according to the principles of the disclosure. The gas temperature and pressure have critical upper and lower ranges which an onboard electronic system monitors through embedded gas temperature sensors and pressure gauges as shown in FIG. 12. This monitoring system may record performance results and transfer them by a wired or wireless communication channel (as described below) to an operation headquarters.

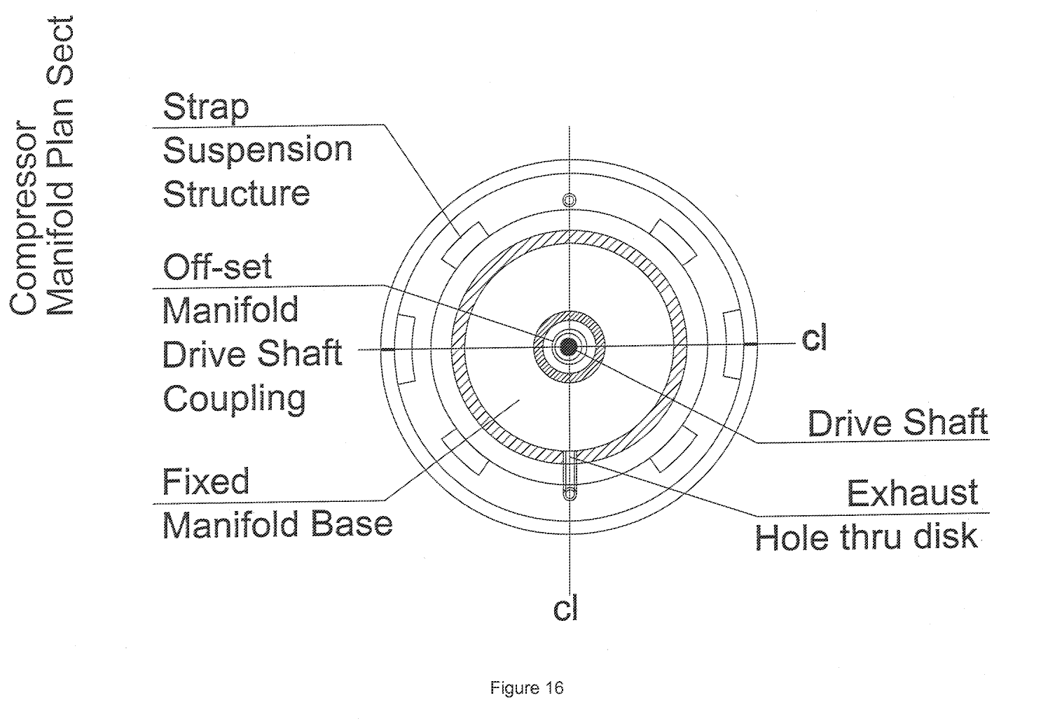

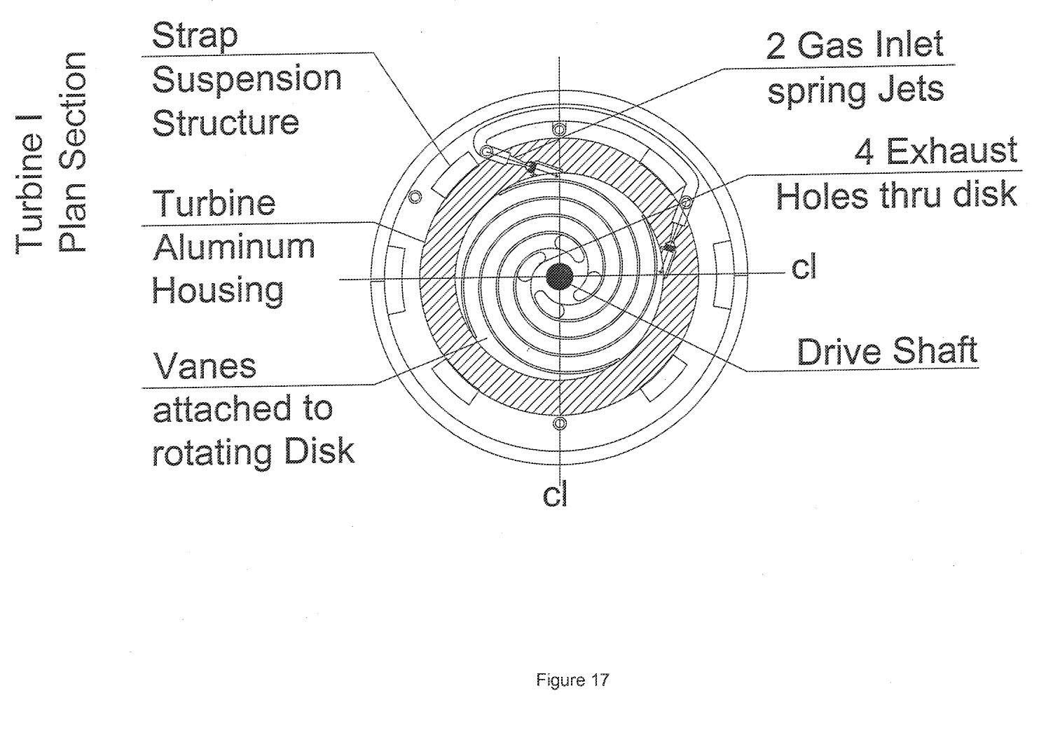

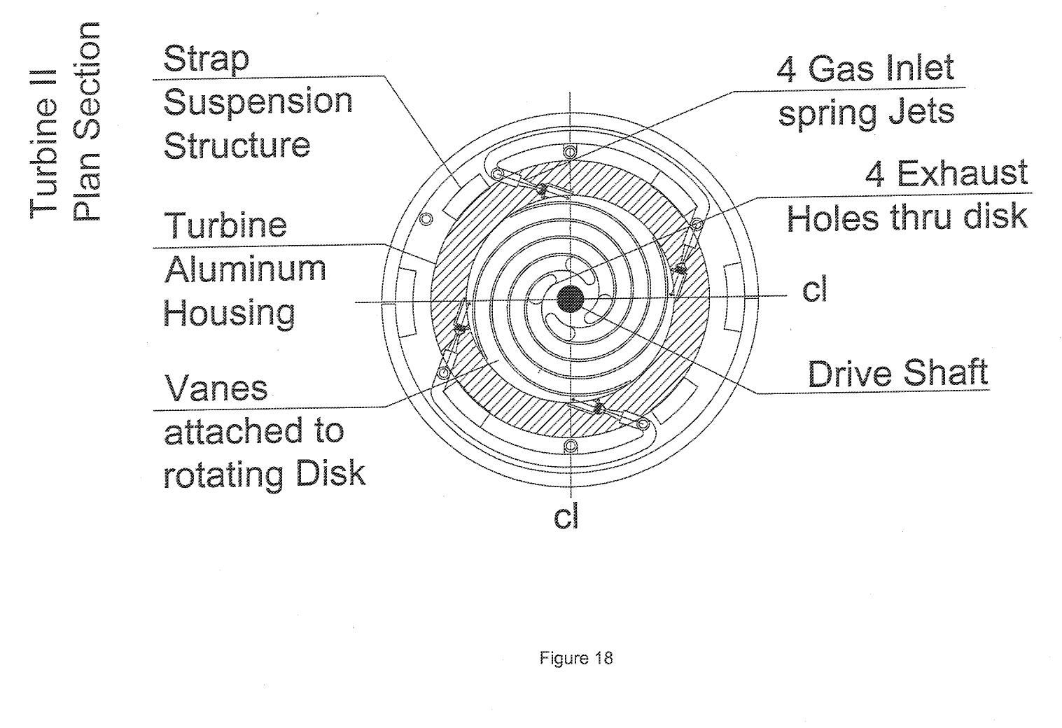

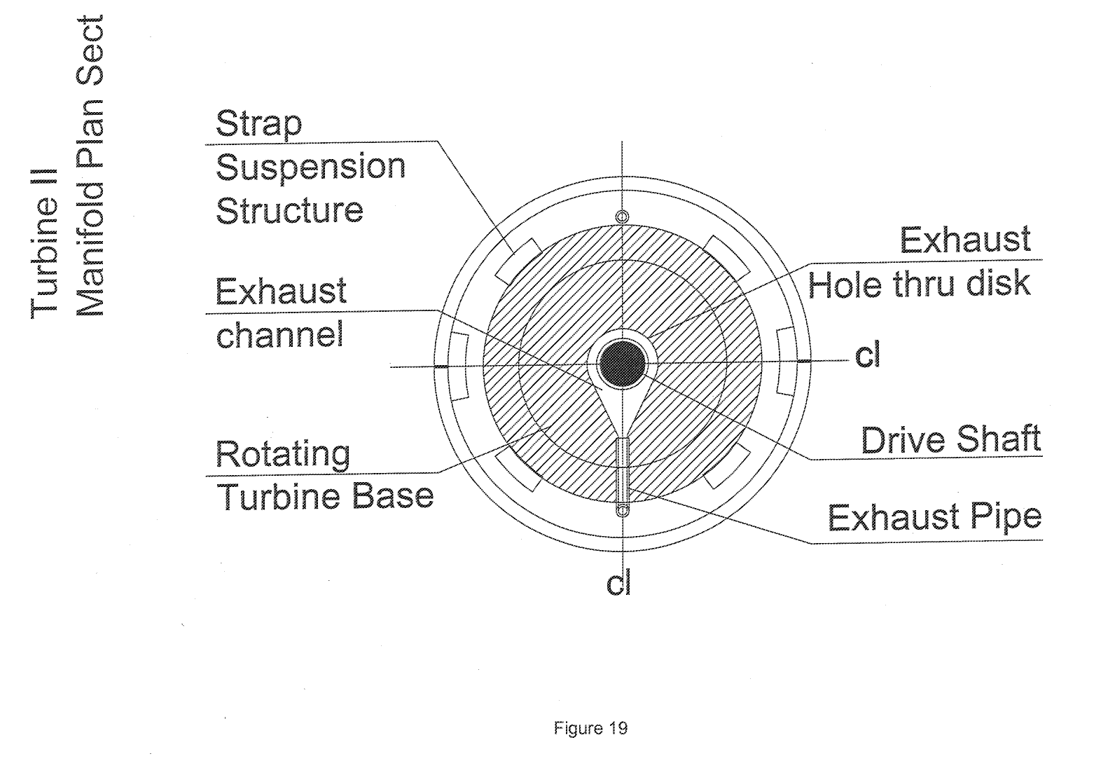

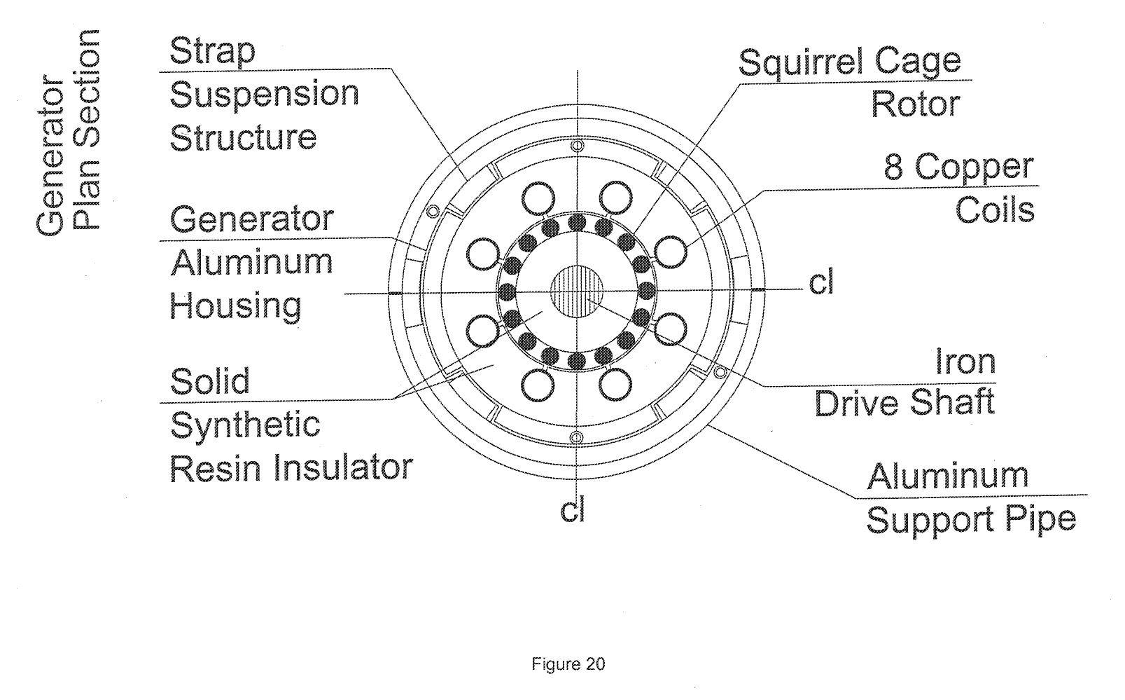

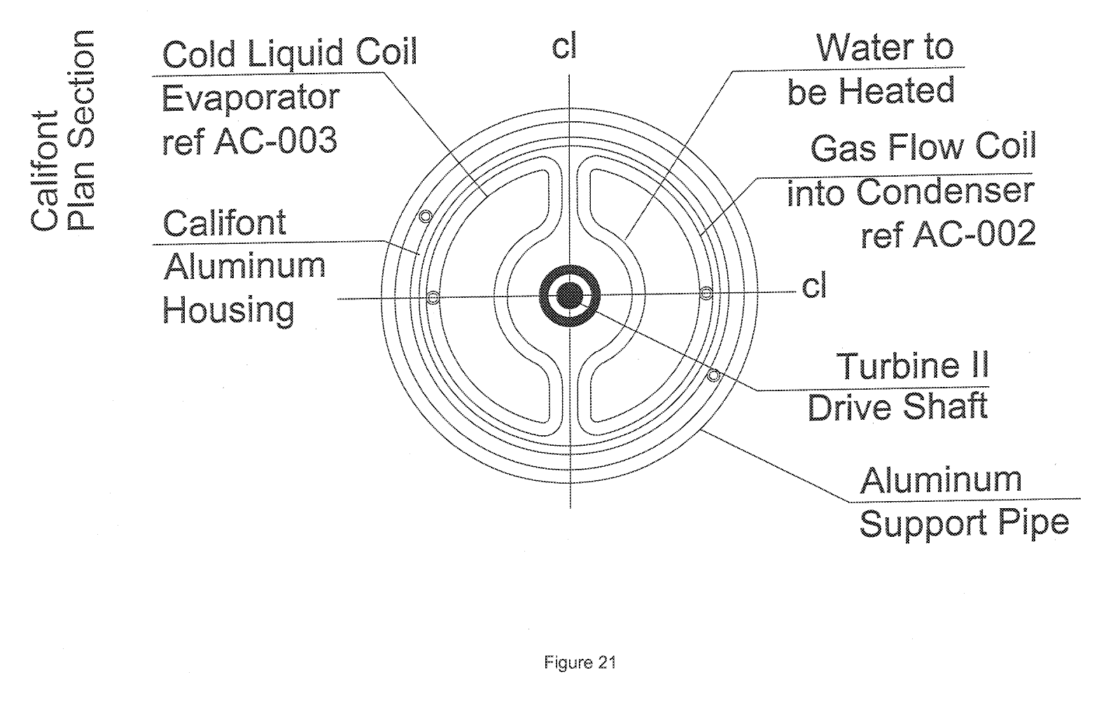

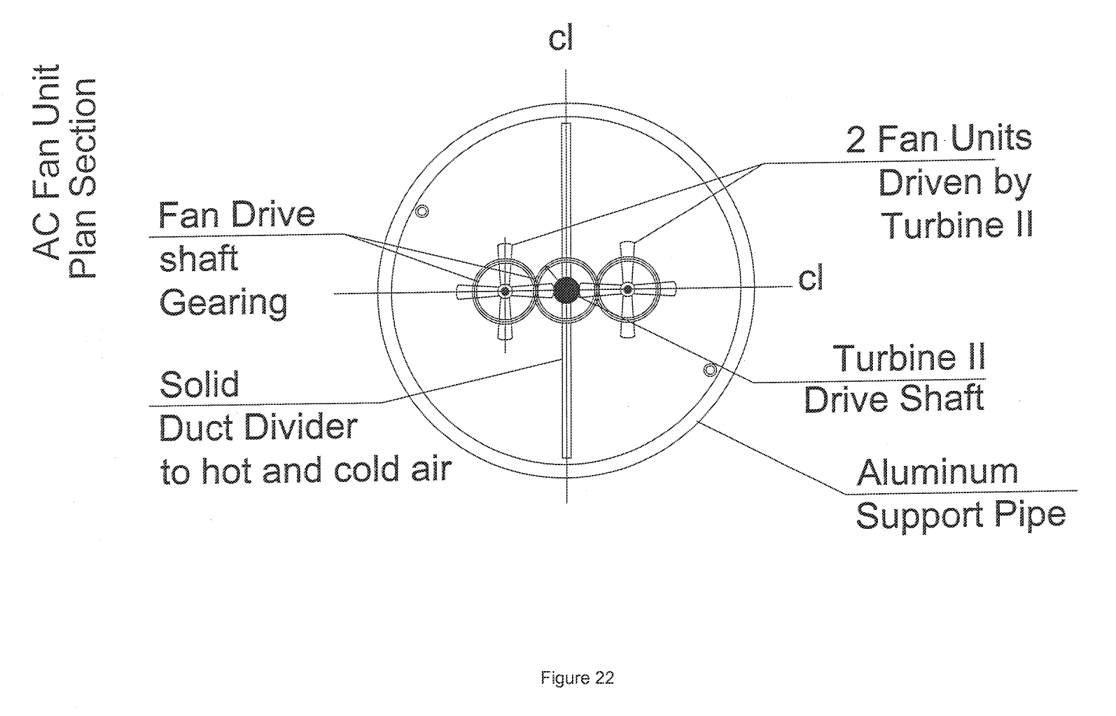

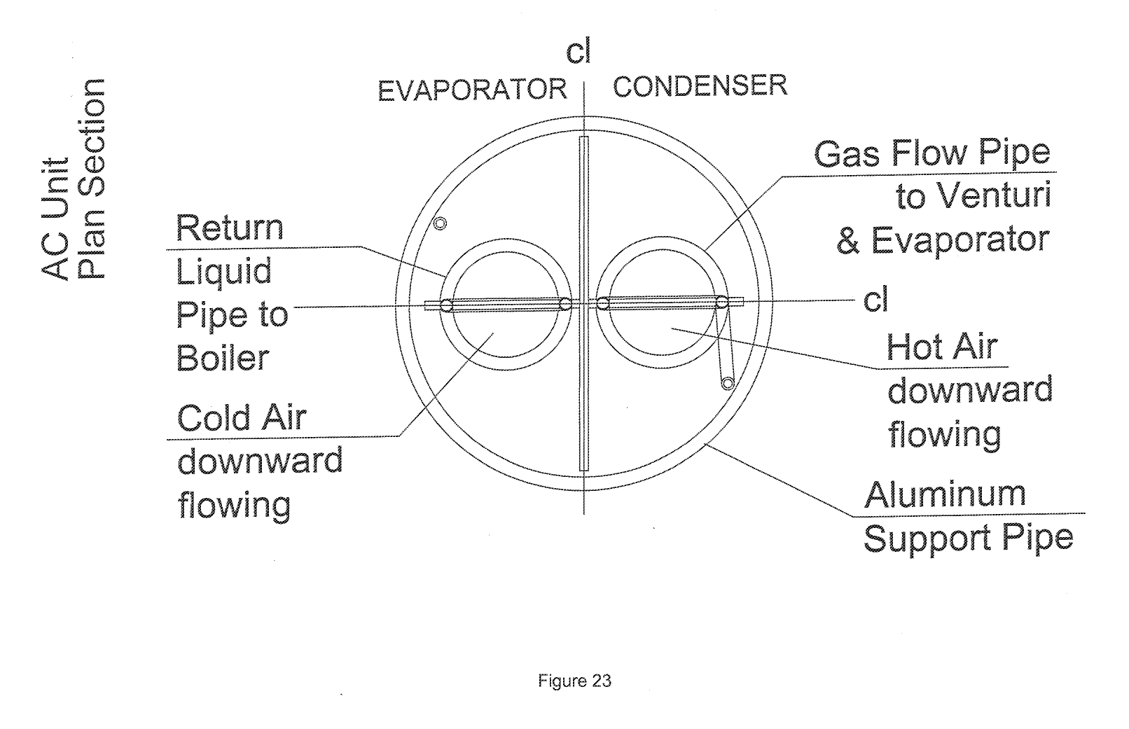

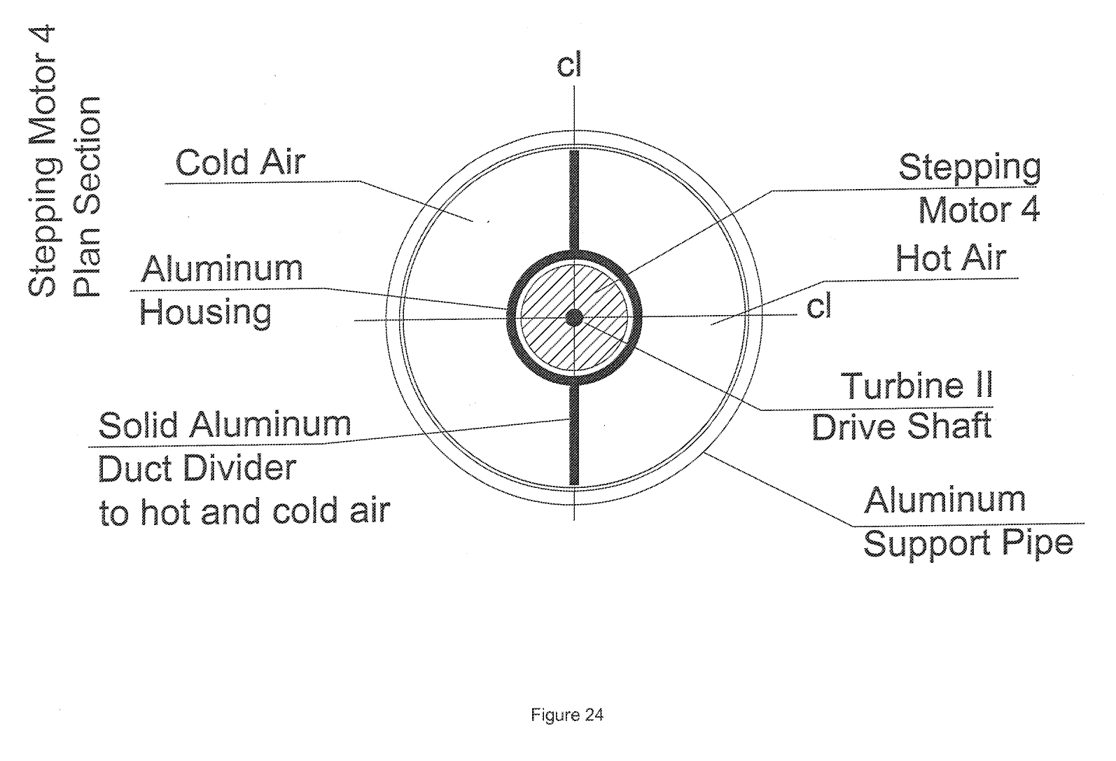

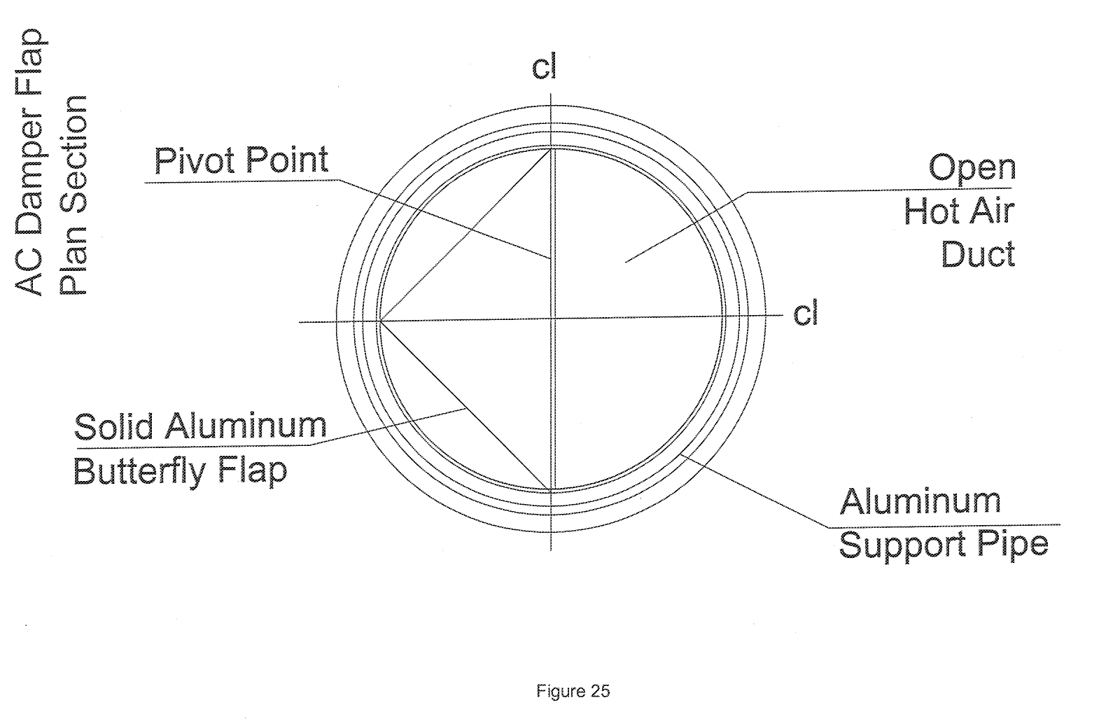

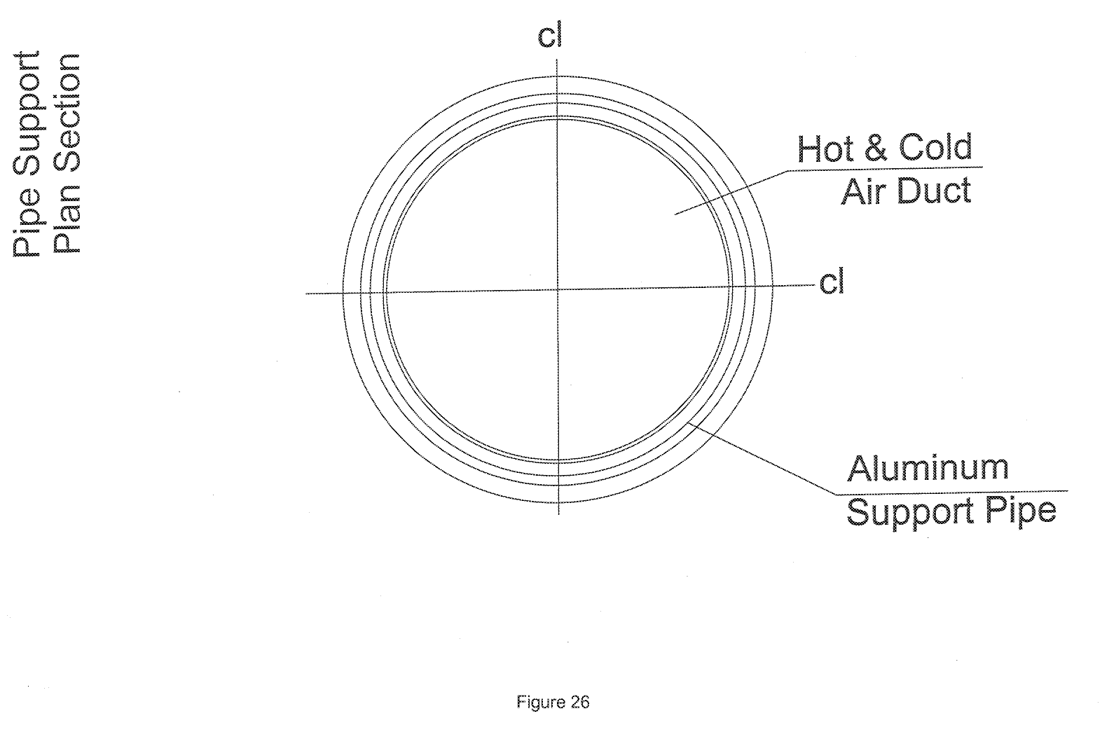

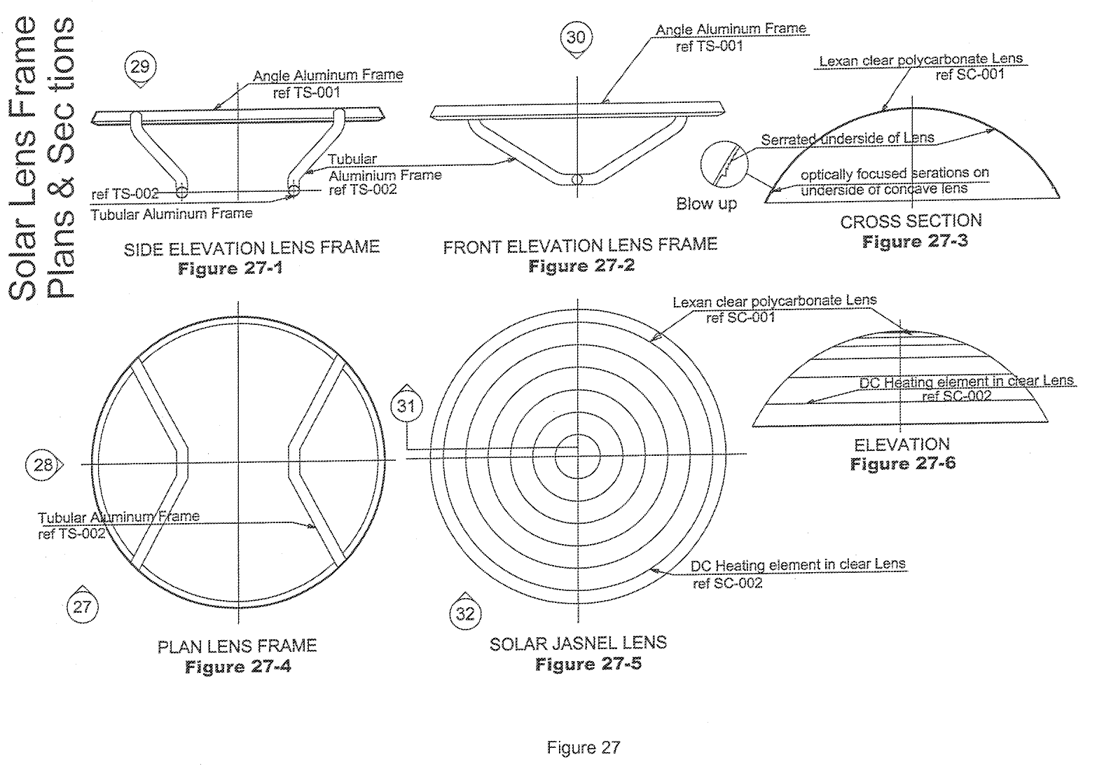

FIG. 16 shows a plan turbine manifold constructed according to the principles of the disclosure; FIG. 17 shows a plan turbine i constructed according to the principles of the disclosure; and FIG. 18 shows a plan turbine ii constructed according to the principles of the disclosure. During the super heating phase, the gas may be dried and as a result it may further increase its temperature and pressure. The super-heated gas in line 1 will drive turbine I which in turn may propel a scroll compressor unit. The turbine may have a tesla scroll style vane turbine. Further the turbine may have a 6″ diameter. The turbine may have either 4 or 8 disk separated vanes. The turbine shaft may drive either a micro multi valve piston or a scroll compressor depending on the size of the solar unit. The scroll compressor may have a double chamber compressing the gas up to 4 times. The piston compressor may triple the gas pressure. Other configurations of the turbine and compressor are within the scope and spirit of the invention.

The super-heated gas in line 2 may pass through a double chamber scroll compressor and into turbine II which powers a squirrel cage micro generator unit. The turbine II may be double the size of turbine I and similar in design. The induction rotor may rotate the squirrel cage and the squirrel cage may include non-permanent magnets attached to a magnetic drive shaft. The rotation causes the squirrel cage magnets to pass copper coils which are embedded into a solid resin armature. It is this action that causes the flow of electricity producing single or three phase AC electricity. Each revolution of the rotor causes electricity to flow into the consumers switch board or back onto the service grid. A second power line runs from a PCB AC/DC inverter on the system motherboard to operate the electronic control system. DC electricity is used by the system to operate the tracking frame stepping motors, pumps, valves and the various heating elements and electronic components.

After passing through turbine I, the gas is at a reduced pressure, and is exhausted back into the boiler liquid chamber where it re-enters the gas cycle.

The design operating parameters of the system may include:

1. The hanex gas temperature may be maintained at about 80 degrees Fahrenheit.

2. The hanex gas pressure may be maintained between 100 to 250 psi gauge pressure depending on weather.

3. The turbines may revolve at an approximately constant 3,600 to 7,200 RPM.

4. Power produced may be at 60 Hz.

5. Torque developed may be between 16 to 22 lbs.

6. Horse power developed will be between 22 to 40 HP.

7. Output of electricity may be in the order of 16.5 to 30 kwh.

As shown in the figures, the gas which is exhausted from turbine II, on its return to the boiler may flow through a condenser, a venturi valve and an evaporator to turn it back to a liquid for entry into the boiler liquid chamber where it may re-enter the liquid cycle. As the gas passes through the condenser it may give off hot air which may be exhausted through a duct into an air conditioning system. After passing through the condenser, the gas may flow through a venturi valve where it turns back to a liquid. As this liquid flows on through the evaporator coil it may give off cool air which will be exhausted through a duct into the air conditioning system. After passing through the evaporator, the liquid may be pumped back to the boiler where the rankine style cycle recommences.

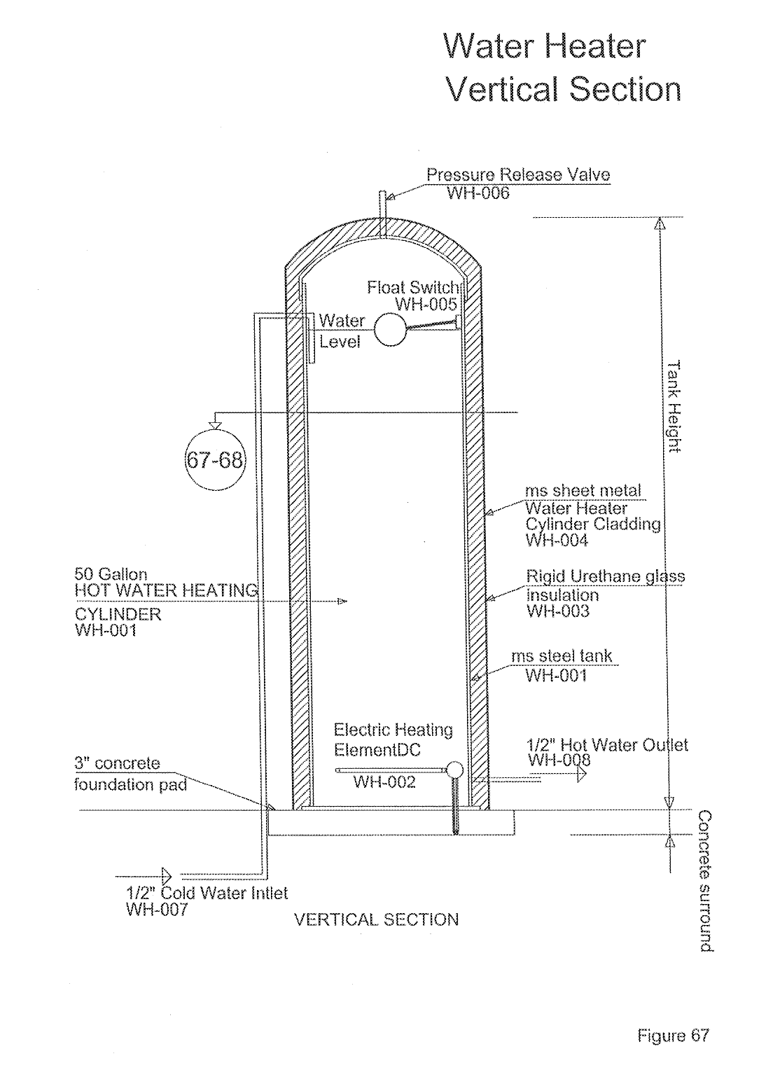

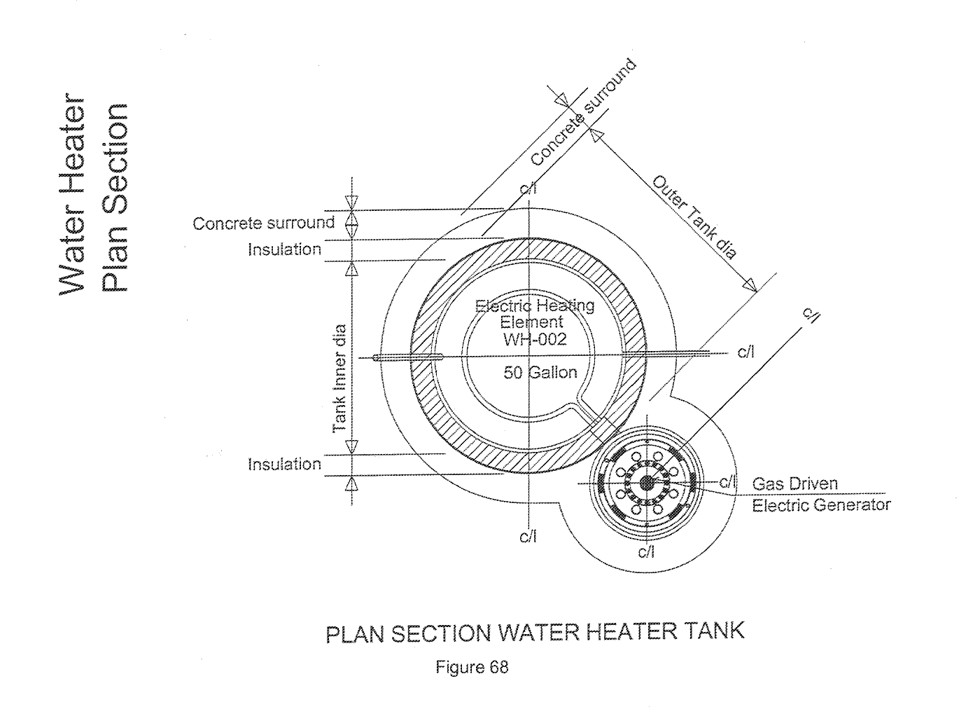

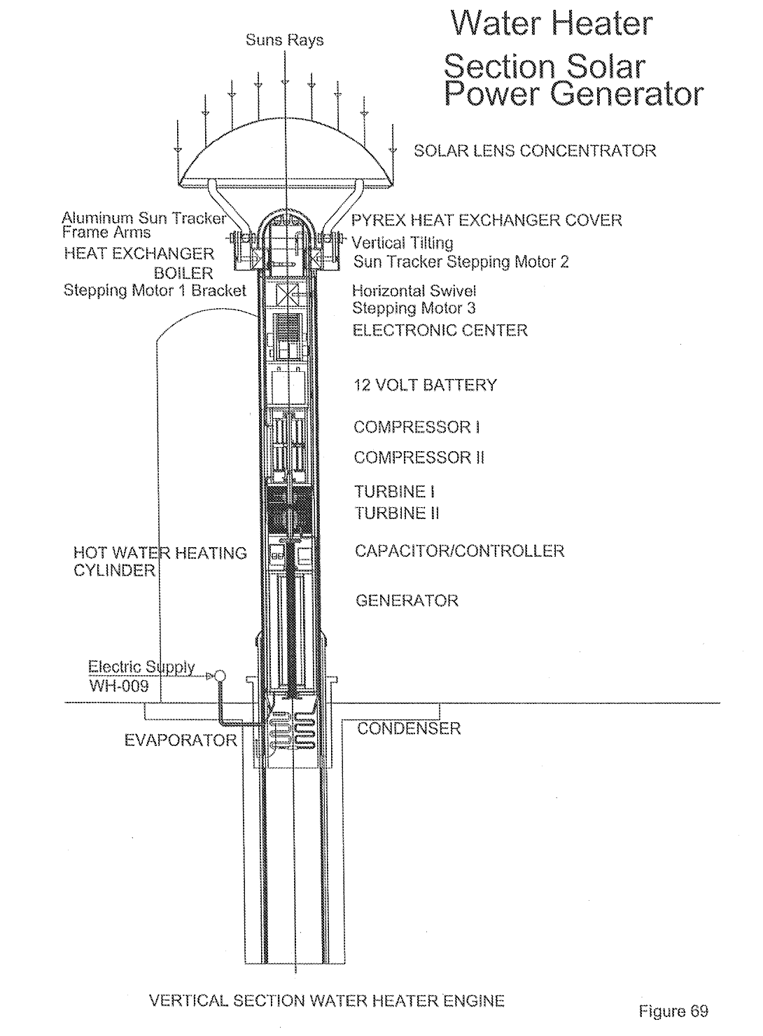

FIG. 67 shows a water heater vertical section (referenced as HWH) constructed according to the principles of the disclosure; FIG. 68 shows a water heater plan section constructed according to the principles of the disclosure; and FIG. 69 shows a water heater solar generator section constructed according to the principles of the disclosure. In particular, the califont may serve to take heat out of the gas by passing it through a pipe coil. Within the califont is immersed a heat exchanger may provide hot water for domestic washing, space heating and water purification for drinking.

Where hot water consumption is higher, a separate hot water heater may be used. This unit may operate off a standard solar unit which produces electricity to power an electrical AC element at the base of the cylinder. The standard solar unit may include a tracking Fresnel lens, heat exchanger, boiler, stepping motors, battery storage cell, double unit scroll compressor, double turbine drive, micro squirrel cage generator, condenser and evaporator and the like. The system may be charged with the hanex liquid.

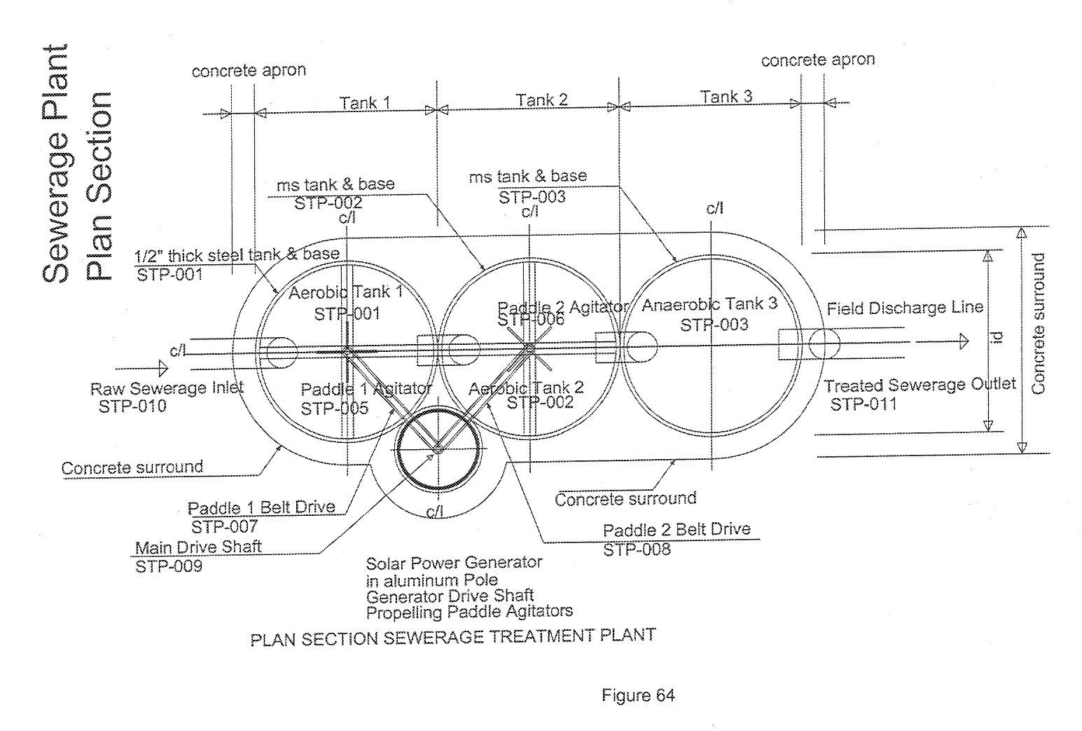

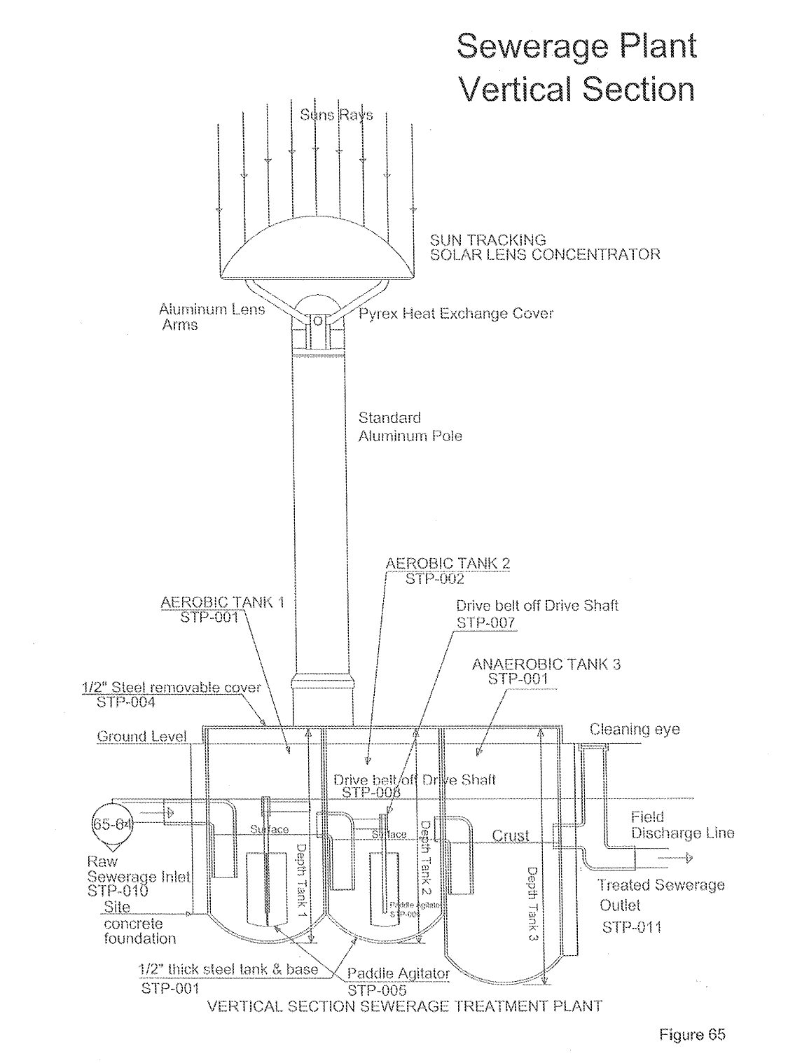

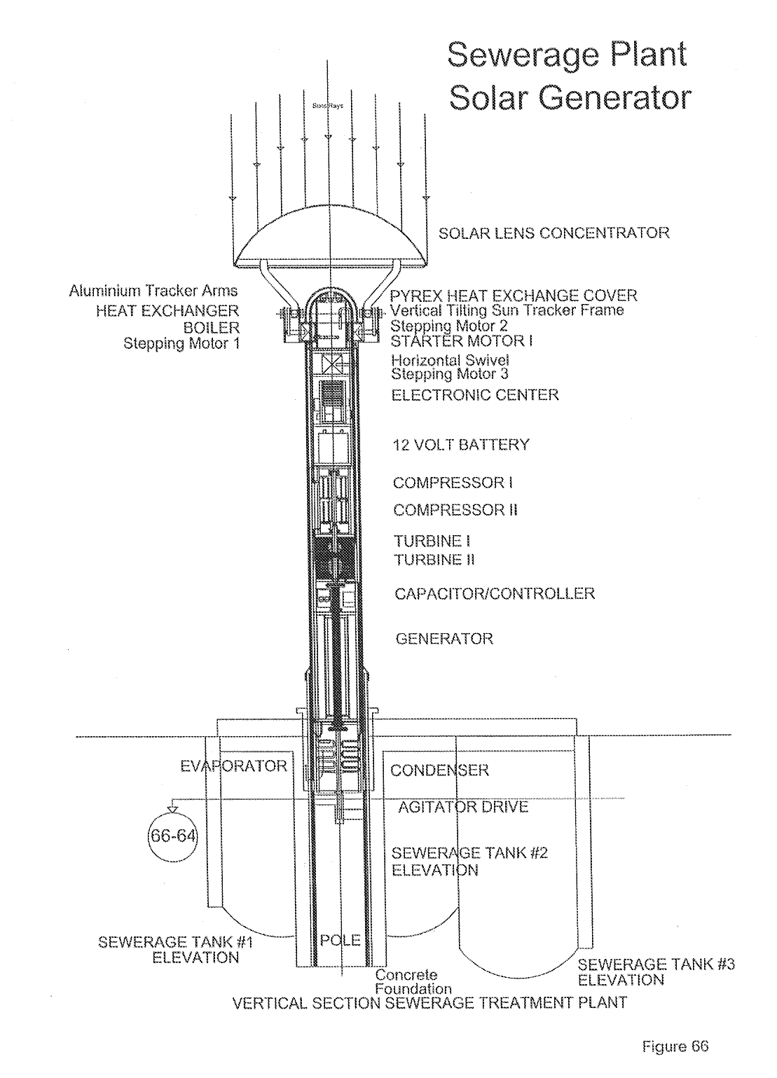

FIG. 64 shows a sewage treatment plant plan section STP constructed according to the principles of the disclosure; FIG. 65 shows a sewage treatment plant vertical section constructed according to the principles of the disclosure; and FIG. 66 shows a sewage treatment section solar generator constructed according to the principles of the disclosure. To treat sewage the standard solar unit may be used to power agitators in the primary aerobic treatment tanks. Once broken down, the raw sewage flows into a secondary anaerobic tank where it is left to settle and finally break down. This unit operates off a standard solar unit which produces electricity to power an electrical AC element at the base of the cylinder. The standard solar unit may include a tracking Fresnel lens, heat exchanger, boiler, stepping motors, battery storage cell, double unit scroll compressor, double turbine drive, micro squirrel cage generator, condenser and evaporator. The system may be charged with hanex liquid.

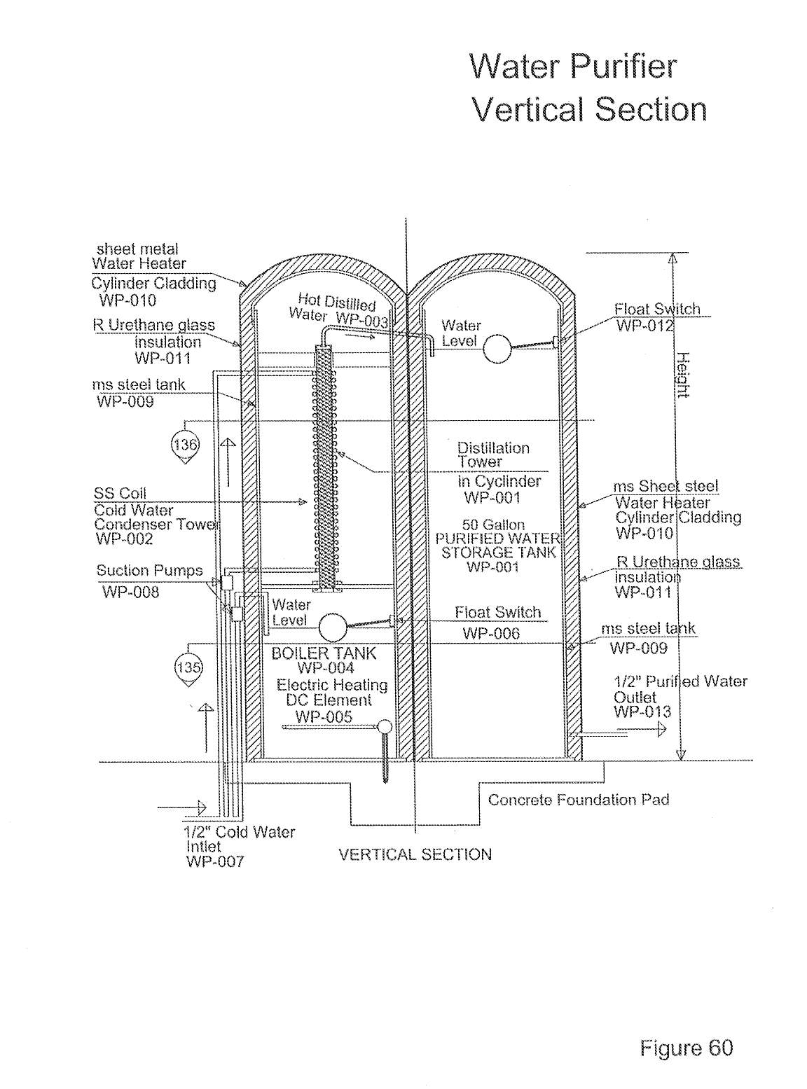

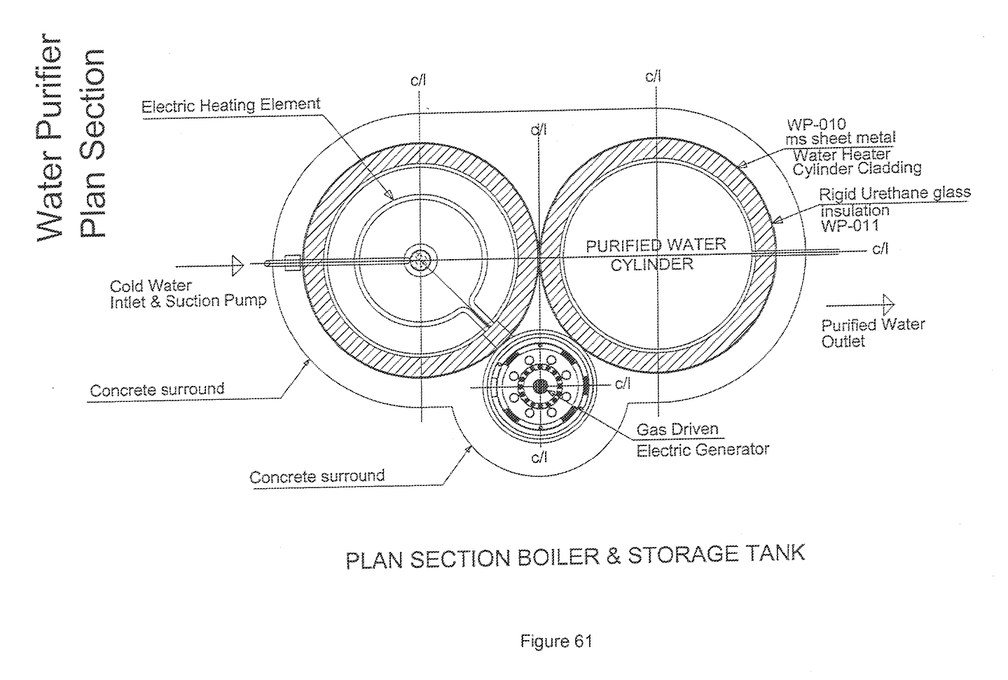

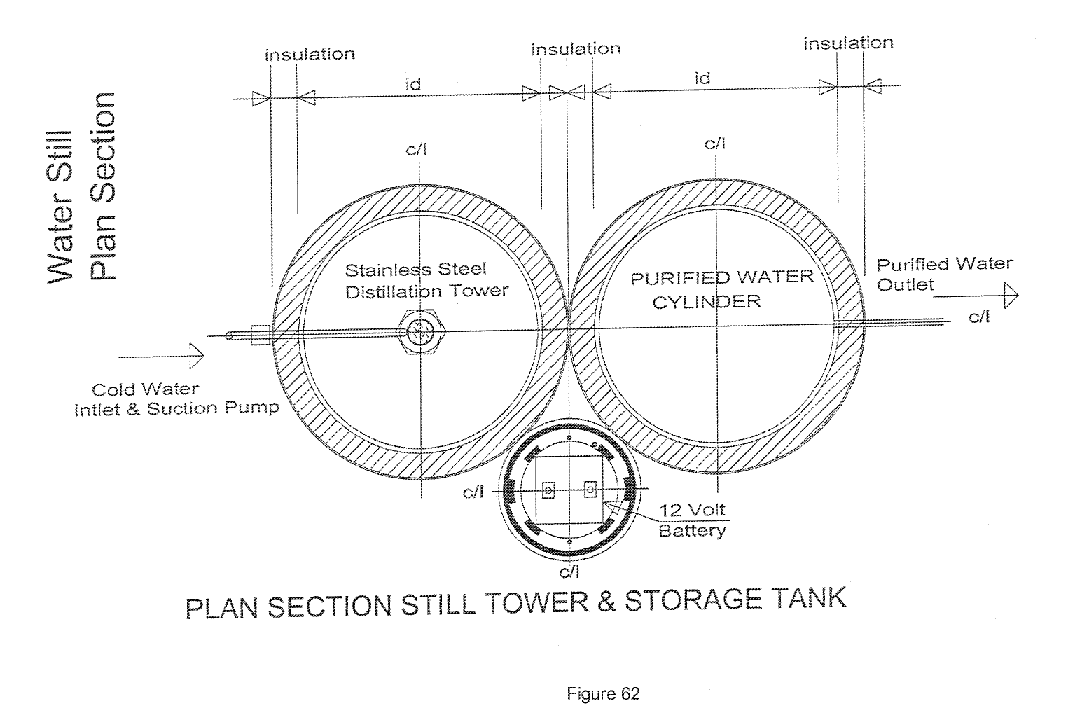

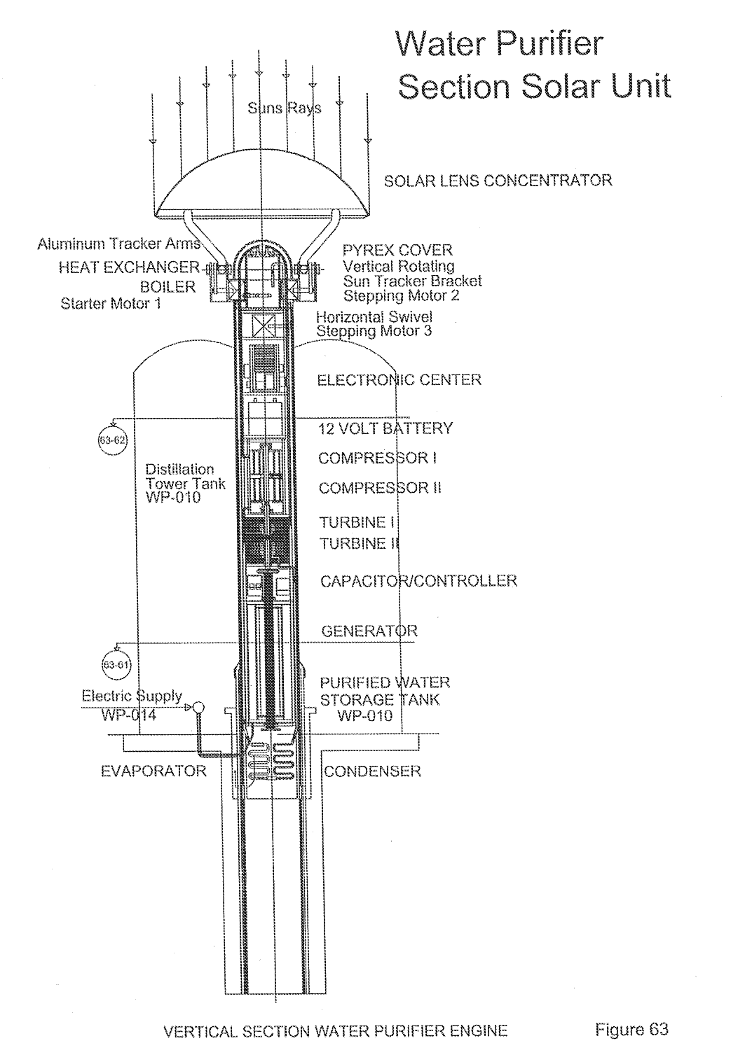

FIG. 60 shows a water purifier vertical section (referenced as WP) constructed according to the principles of the disclosure; FIG. 61 shows a water purifier plan section constructed according to the principles of the disclosure; FIG. 62 shows a water purifier plan section still constructed according to the principles of the disclosure; and FIG. 63 shows a water purifier solar unit constructed according to the principles of the disclosure. This unit may include a standard solar unit producing electricity to power an electrical AC element at the base of the boiler unit. Evaporated steam passes through a condenser where it turns back to purified water and is stored in adjoining storage tank. This unit may also operate off a standard solar unit which produces electricity to power an electrical AC element at the base of the cylinder. The standard solar unit may include a tracking Fresnel lens, heat exchanger, boiler, stepping motors, battery storage cell, double unit scroll compressor, double turbine drive, micro squirrel cage generator, condenser and evaporator. The system may be charged with hanex liquid.

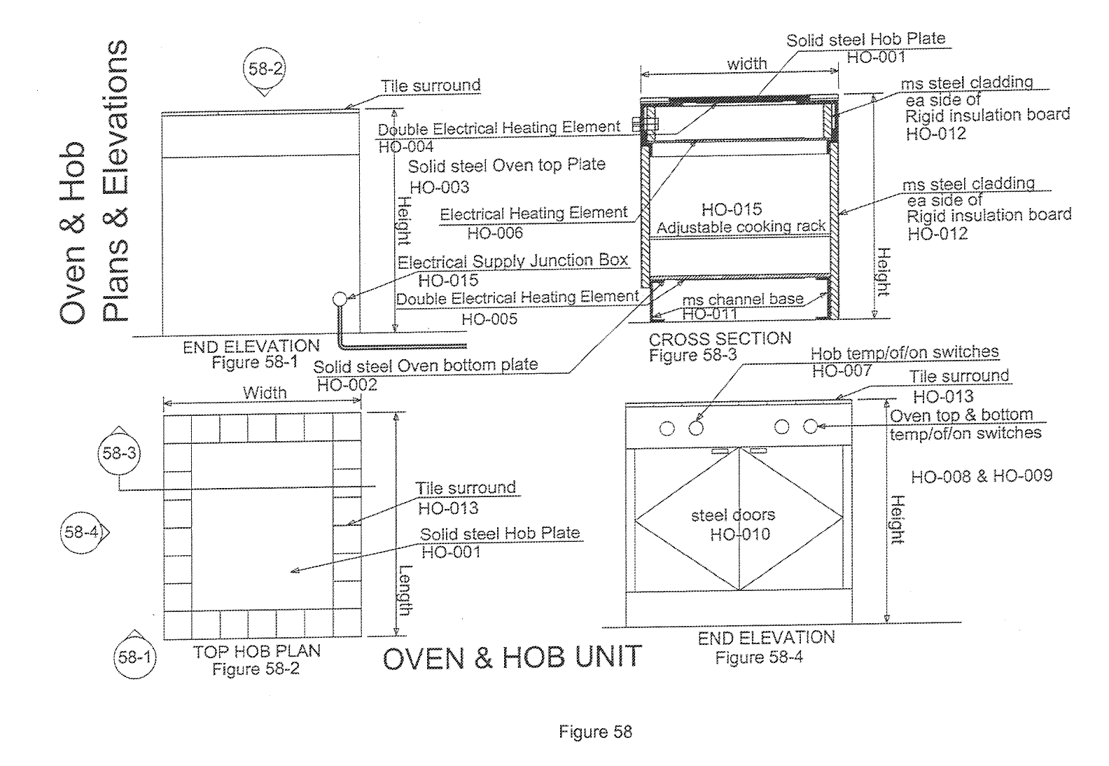

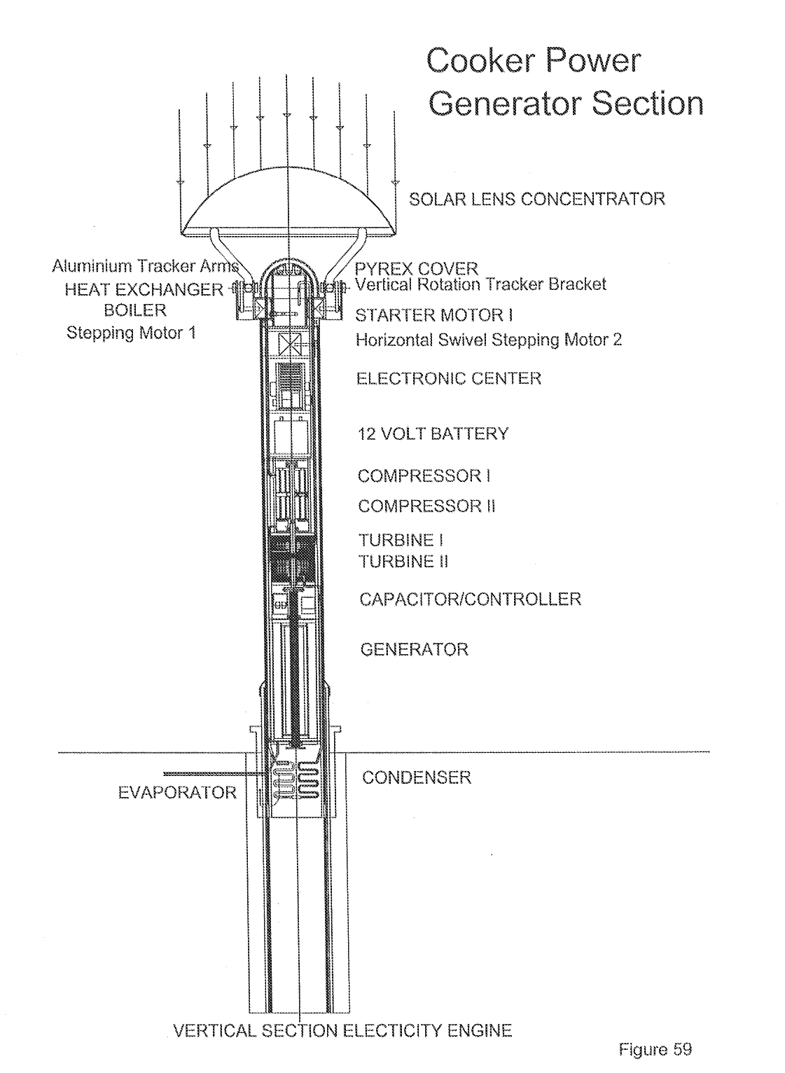

FIG. 58 shows an oven & hob (referenced as HB) constructed according to the principles of the disclosure; and FIG. 59 shows a cooker solar generator constructed according to the principles of the disclosure. This unit may include a standard solar unit producing electricity to power an electrical AC element at the base of hob plate and oven base and top plates. This unit may also operate off a standard solar unit which produces electricity to power an electrical AC element at the base of the cylinder. The standard solar unit may include a tracking Fresnel lens, heat exchanger, boiler, stepping motors, battery storage cell, double unit scroll compressor, double turbine drive, micro squirrel cage generator, condenser and evaporator. The system may be charged with hanex liquid.

All of the components of the heat exchanger, boiler, compressor, turbines, califont, AC and electronics system may fit within a support pole. For example, the support pole may be a 10″ diameter aluminum support pole which is set in an aluminum tubular sleeve cast in a concrete in the ground. Other size and material poles are also contemplated. Within the pole may also be a battery, such as a 12 volt battery, for storage of required system DC operating electricity.

In high winds (i.e., hurricanes wind) will pass through slots in the curved solar lens to reduce damage. The solar energy system is also configured to so that rain will run off it. The reflector may be fitted with a low voltage DC element to melt snow and ice should it cling to the lens or frame.

From a design point of view each exposed part of the supporting pole and the solar lens and tracking unit frame may be mirror coated to make the unit appear semitransparent.
1. A solar concentrator Fresnel lens is shown in the drawings and labeled SC.
2. Polycarbonate concave lens is shown in the drawings and labeled SC-001.
3. A DC lens heating element is shown in the drawings and labeled SC-002.
4. A tracking system is shown in the drawings and labeled TS.
5. Aluminum tracking system lens frame is shown in the drawings and labeled TS-001.
6. Aluminum tracking system frame arms are shown in the drawings and labeled TS-002.
7. Aluminum tracking system vertical tilting bracket and connector are shown in the drawings and labeled TS-003.
8. Left side tilting stepping motor and gearing are shown in the drawings and labeled reference TS-004a.
9. Right side tilting stepping motor and gearing are shown in the drawings and labeled reference TS-004b.
10. Horizontal rotational stepping motor and gearing are shown in the drawings and labeled reference TS-005.
11. The heat exchanger is shown in the drawings and labeled HE.
12. Heat exchanger Pyrex glass gas cast dome shaped cover is shown in the drawings and labeled HE-001.
13. Heat exchanger aluminum conductor finned shield is shown in the drawings and labeled HE-002.
14. The ⅜″ diameter aluminum coil 1 heat exchanger gas line 1 is shown in the drawings and labeled HE-003a.
15. The ⅜″ diameter aluminum coil 2 heat exchanger gas line 2 is shown in the drawings and labeled HE-003b.
16. The ⅜″ diameter aluminum gas line couplings is shown in the drawings and labeled HE-004.
17. A boiler is shown in the drawings and labeled BL.
18. Aluminum boiler housing cylinder with top and base is shown in the drawings and labeled BL-001.
19. Boiler return gas flow pipe is shown in the drawings and labeled BL-002.
20. Boiler screw in top plug with gas 2 gas outlet pipes and refrigerant charge valve is shown in the drawings and labeled BL-003.
21. Boiler DC heating element reference BL-004.
22. An electronic system is shown in the drawings and labeled ES.
23. The electronic system computer mother board is shown in the drawings and labeled ES-001.
24. The electronic system computer key pad is shown in the drawings and labeled ES-002.
25. The electronic system computer PCB #1 tracker unit is shown in the drawings and labeled ES-003.
26. The electronic system computer PCB #2 turbine inlet valves is shown in the drawings and labeled ES-004.
27. The electronic system computer PCB #3 turbine control is shown in the drawings and labeled ES-005.
28. The electronic system computer PCB #4 temperature readings is shown in the drawings and labeled ES-006.
29. The electronic system computer PCB #5 inverter is shown in the drawings and labeled ES-007.
30. The electronic system computer PCB #6 battery is shown in the drawings and labeled ES-008.
31. The electronic system computer PCB #7 weather records is shown in the drawings and labeled ES-009.
32. The electronic system computer PCB #8 GPS is shown in the drawings and labeled ES-010.
33. The electronic system computer PCB #9 gas pressure gauges is shown in the drawings and labeled ES-010.
34. The electronic system computer PCB #10 liquid level gauge is shown in the drawings and labeled ES-010.
35. The electronic system computer room is shown in the drawings and labeled ES-011.
36. The electronic system computer ram is shown in the drawings and labeled ES-012.
37. The electronic system computer time clock is shown in the drawings and labeled ES-013.
38. The electronic system computer microprocessor is shown in the drawings and labeled ES-014.
39. The electronic system computer USB connection is shown in the drawings and labeled ES-015.
40. The electronic system computer Wi-Fi is shown in the drawings and labeled ES-016.
41. The electronic system computer input/output device is shown in the drawings and labeled ES-017.
42. The electronic system computer dc power connector is shown in the drawings and labeled ES-018.
43. The electronic system computer generator capacitor connector is shown in the drawings and labeled ES-019.
44. A compressor is shown in the drawings and labeled CR.
45. Aluminum pipe housing is shown in the drawings and labeled CR-001.
46. Aluminum screw in top base plate is shown in the drawings and labeled CR-002a.
47. Aluminum screw in center exhaust manifold plate is shown in the drawings and labeled CR-003.
48. Aluminum screw in bottom base plate is shown in the drawings and labeled CR-004.
49. Aluminum screw in bottom exhaust chamber base plate is shown in the drawings and labeled CR-005.
50. Kevlar fixed Archimedes scroll compressor 1 is shown in the drawings and labeled CR-006a.
51. Kevlar fixed Archimedes scroll compressor 2 is shown in the drawings and labeled CR-006b.
52. Kevlar rotating Archimedes scroll compressor 1 is shown in the drawings and labeled CR-007a.
53. Kevlar rotating Archimedes scroll compressor 2 is shown in the drawings and labeled CR-007b.
54. The ¾″ diameter stainless steel drive shaft is shown in the drawings and labeled CR-008.
55. The ¾″ inside diameter stainless steel drive shaft offset coupling is shown in the drawings and labeled CR-009.
56. Stainless steel spring loaded converging diverging gas inlet jet (2) is shown in the drawings and labeled CR-010.
57. Ceramic drive shaft top bearings are shown in the drawings and labeled CR-011a.
58. Ceramic drive shaft bottom bearings are shown in the drawings and labeled CR-011b.
59. Kevlar drive shaft top flexible seal are shown in the drawings and labeled CR-012a.
60. Kevlar drive shaft bottom flexible seal are shown in the drawings and labeled CR-012b.
61. Turbines are shown in the drawings and labeled TT.
62. Aluminum turbine housing is shown in the drawings and labeled TT-001.
63. Kevlar turbine I with 4 rotating blades attached to a turbine drive shaft is shown in the drawings and labeled TT-002a.
64. Kevlar turbine I with one turbine blade top plate attached to a turbine drive shaft is shown in the drawings and labeled TT-002b.
65. Kevlar turbine II with eight rotating blades attached to turbine drive shaft is shown in the drawings and labeled TT-003a.
66. Kevlar turbine II with one turbine blade top plate attached to turbine drive shaft is shown in the drawings and labeled TT-003b.
67. Aluminum turbine I housing top plate is shown in the drawings and labeled TT-004.
68. Aluminum turbine II housing bottom plate and exhaust manifold is shown in the drawings and labeled TT-005.
69. Ceramic drive shaft top bearings are shown in the drawings and labeled TT-006a.
70. Ceramic drive shaft bottom bearings are shown in the drawings and labeled TT-006b.
71. Kevlar drive shaft top flexible seal is shown in the drawings and labeled TT-007a.
72. Kevlar drive shaft bottom flexible seal is shown in the drawings and labeled TT-007b.
73. Stainless steel spring loaded converging diverging gas inlet jet turbine I (4) is shown in the drawings and labeled TT-008a.
74. Stainless steel spring loaded converging diverging gas inlet jet turbine II (16) is shown in the drawings and labeled TT-008b.
75. The “o” rings to seal joints with top and bottom cover plates (2) are shown in the drawings and labeled TT-009.
76. The ¾″ diameter mild steel drive shaft to turbine I is shown in the drawings and labeled TT-010.
77. The ¾″ diameter mild steel drive shaft and generator coupling on turbine II is shown in the drawings and labeled TT-011.
78. The generator is shown in the drawings and labeled GR.
79. Stainless steel cylindrical housing is shown in the drawings and labeled GR-001.
80. One ½″ diameter laminated electrical steel grade drive shaft with insulated coupling to turbine is shown in the drawings and labeled GR-002.
81. 16 magnet squirrel cage rotor is shown in the drawings and labeled GR-003.
82. One 1″ diameter vertical copper bank of coils (8) set in a resin core as stator is shown in the drawings and labeled GR-004.
83. A capacitor exciter is shown in the drawings and labeled GR-005.
84. A control unit is shown in the drawings and labeled GR-006.
85. A califont is shown in the drawings and labeled CF.
86. A ¼″ mild steel califont pipe case is shown in the drawings and labeled CF-001.
87. A ⅜″ diameter stainless steel gas flow pipe coil element is shown in the drawings and labeled CF-002.
88. A ⅜″ diameter cold water inlet pipe coupling is shown in the drawings and labeled CF-003.
89. A ⅜″ diameter hot water outlet pipe coupling is shown in the drawings and labeled CF-004.
90. A ¾″ diameter mild steel drive shaft and generator coupling on turbine II is shown in the drawings and labeled CF-005.
91. An AC system is shown in the drawings and labeled AC.
92. Stainless steel cast fan #1 is shown in the drawings and labeled AC-001a.
93. Stainless steel cast fan #2 is shown in the drawings and labeled AC-001b.
94. Aluminum sheet condenser plate is shown in the drawings and labeled AC-002.
95. Aluminum sheet evaporator plate is shown in the drawings and labeled AC-003.
96. A ⅜″ diameter aluminum gas & liquid flow coil pipe-work is shown in the drawings and labeled AC-004.
97. Venturi valve is shown in the drawings and labeled AC-005.
98. Liquid pressure pump is shown in the drawings and labeled AC-006.
99. Stepping motor #4 to drive butterfly damper valve is shown in the drawings and labeled AC-007.
100. Stepping motor #4 stainless steel housing is shown in the drawings and labeled AC-008.
101. A 1/16″ thick stainless steel butterfly damper and pivot rod is shown in the drawings and labeled AC-009.
102. An “o” ring to seal damper edges is shown in the drawings and labeled AC-010.
103. A ¾″ diameter stainless steel drive shaft is shown in the drawings and labeled AC-011.
104. Support structure is shown in the drawings and labeled ss.
105. One ½″×½″ thick suspension straps (4) is shown in the drawings and labeled ss-001.
106. A ½″ thick×8″ diameter support disks (8) is shown in the drawings and labeled ss-002.
107. A 10¾″ outside diameter mild steel pipe column is shown in the drawings and labeled ss-003.
108. Ceramic swivel top bearings are shown in the drawings and labeled ss-004.
109. One ⅜″ mild steel joining strip is shown in the drawings and labeled ss-005
110. Pipework is shown in the drawings and labeled PW.
111. A ⅜″ outside diameter stainless steel gas flow lines 1 & 2 is shown in the drawings and labeled PW-001a.
112. A ⅜″ outside diameter stainless steel gas & liquid return line is shown in the drawings and labeled PW-001b.
113. ¼″ thick polyurethane insulation to gas flow lines is shown in the drawings and labeled PW-002a.
114. ¼″ thick polyurethane insulation to gas & liquid return lines is shown in the drawings and labeled PW-002b.
115. An electrical system is shown in the drawings and labeled EE.
116. Wiring tough plastic sheathed is shown in the drawings and labeled EE-001.
117. A distribution board is shown in the drawings and labeled EE-002.
118. A phase 1 bus bar is shown in the drawings and labeled EE-003.
119. A phase 2 bus bar is shown in the drawings and labeled EE-004.
120. A phase 3 bus bar is shown in the drawings and labeled EE-005.
121. A neutral bus bar is shown in the drawings and labeled EE-006.
122. A frequency synchronizer is shown in the drawings and labeled EE-007.
123. A MCB 1 phase is shown in the drawings and labeled EE-008.
124. A MCB 3 phase is shown in the drawings and labeled EE-009.
125. A voltage regulator is shown in the drawings and labeled EE-010.
126. A three phase supply connection to consumer is shown in the drawings and labeled EE-011.
127. A three phase supply connection to grid is shown in the drawings and labeled EE-012.
128. Refrigerant is shown in the drawings and labeled RF.
129. Hanex refrigerant is shown in the drawings and labeled RF-001.
130. A hob & oven is shown in the drawings and labeled HO.
131. Hob plate is shown in the drawings and labeled HO-001.
132. Oven bottom plate is shown in the drawings and labeled HO-002.
133. Oven top plate is shown in the drawings and labeled HO-003.
134. Hob plate elements is shown in the drawings and labeled HO-004.
135. Oven bottom plate element is shown in the drawings and labeled HO-005.
136. Oven top plate element is shown in the drawings and labeled HO-006.
137. Hob plate thermostatic controlled on/off temperature switches is shown in the drawings and labeled HO-007.
138. Oven top plate thermostatic controlled on/off temperature switch is shown in the drawings and labeled HO-008.
139. Oven bottom plate thermostatic controlled on/off temperature switch is shown in the drawings and labeled HO-009.
140. Oven side hung sealed oven doors is shown in the drawings and labeled HO-010.
141. Cooking unit carcass steel frame is shown in the drawings and labeled HO-011.
142. Cooking unit carcass insulation panels is shown in the drawings and labeled HO-012.
143. Ceramic tile surround to cooking hob plate is shown in the drawings and labeled HO-013.
144. Cooking unit electrical supply junction box is shown in the drawings and labeled HO-014.
145. Electrical supply junction box is shown in the drawings and labeled HO-015.
146. A water purifier is shown in the drawings and labeled WP.
147. Distillation tower is shown in the drawings and labeled WP-001.
148. Distillation tower condenser coil is shown in the drawings and labeled WP-002.
149. Distillation tower outlet pipe to storage tank is shown in the drawings and labeled WP-003.
150. Boiler tank is shown in the drawings and labeled WP-004.
151. Boiler element is shown in the drawings and labeled WP-005.
152. Boiler float switch is shown in the drawings and labeled WP-006.
153. Cold supply pipe is shown in the drawings and labeled WP-007.
154. Suction pumps is shown in the drawings and labeled WP-008.
155. Boiler/distillation tower cylinder is shown in the drawings and labeled WP-009.
156. Boiler/distillation tower & storage tank outer case cylinder is shown in the drawings and labeled WP-010.
157. Boiler/distillation tower & storage tank cylinder urethane insulation is shown in the drawings and labeled WP-011.
158. Storage tank float switch reference# is WP-012.
159. Purified water outlet connection is shown in the drawings and labeled wp-013.
160. Electrical supply junction box is shown in the drawings and labeled WP-014.
161. A sewage treatment plant is shown in the drawings and labeled STP.
162. Aerobic tank 1 is shown in the drawings and labeled STP-001.
163. Aerobic tank 2 is shown in the drawings and labeled STP-002.
164. Anaerobic tank 3 is shown in the drawings and labeled STP-003.
165. Sewage tank lid is shown in the drawings and labeled STP-004.
166. Aerobic tank 1 agitator paddle is shown in the drawings and labeled STP-005.
167. Aerobic tank 2 agitator paddle is shown in the drawings and labeled STP-006.
168. Aerobic tank 1 agitator paddle drive belt is shown in the drawings and labeled STP-007.
169. Aerobic tank 1 agitator paddle drive belt is shown in the drawings and labeled STP-008.
170. Sewage treatment plant paddle drive shaft is shown in the drawings and labeled STP-009.
171. Raw sewage inlet pipe is shown in the drawings and labeled STP-010.
172. Treated sewage outlet pipe is shown in the drawings and labeled STP-011.
173. Electrical supply junction box is shown in the drawings and labeled STP-012.
174. A hot water heater is shown in the drawings and labeled WH.
175. Hot water cylinder is shown in the drawings and labeled WH-001.
176. Water heating element is shown in the drawings and labeled WH-002.
177. Cylinder urethane insulation is shown in the drawings and labeled WH-003.
178. Cylinder outer case reference is WH-004.
179. Float switch reference is WH-005.
180. Pressure release valve reference is WH-006.
181. Cold water inlet supply reference is WH-007.
182. Hot water outlet to consumer reference is WH-008.
183. Electrical supply junction box is shown in the drawings and labeled WH-009.

The invention may include communication channels that may be any type of wired or wireless electronic communications network, such as, e.g., a wired/wireless local area network (LAN), a wired/wireless personal area network (PAN), a wired/wireless home area network (HAN), a wired/wireless wide area network (WAN), a campus network, a metropolitan network, an enterprise private network, a virtual private network (VPN), an internetwork, a backbone network (BBN), a global area network (GAN), the Internet, an intranet, an extranet, an overlay network, a cellular telephone network, a Personal Communications Service (PCS), using known protocols such as the Global System for Mobile Communications (GSM), CDMA (Code-Division Multiple Access), W-CDMA (Wideband Code-Division Multiple Access), Wireless Fidelity (Wi-Fi), Bluetooth, and/or the like, and/or a combination of two or more thereof.

While the disclosure has been described in terms of exemplary embodiments, those skilled in the art will recognize that the disclosure can be practiced with modifications in the spirit and scope of the appended claims. These examples given above are merely illustrative and are not meant to be an exhaustive list of all possible designs, embodiments, applications or modifications of the disclosure.

What is claimed is:

1. A solar energy system comprising:
a sun tracking lens mounted on a frame;
a support system to support the solar energy system;
a heat exchanger con Figured so that concentrated light from the lens is focused on the heat exchanger;
a boiler;
a double chamber scroll compressor;
a turbine arranged in the support system; and
a generator unit arranged in the support system.

2. The system of claim 1 wherein the sun tracking lens comprises a circular shape.

3. The system of claim 1 wherein the frame comprises a lightweight aluminum frame.

4. The system of claim 1 wherein said sun tracking lens comprises a swivel mounting.

5. The system of claim 1 wherein said sun tracking lens comprises a Fresnel lens.

6. The system of claim 1 wherein said sun tracking lens is con Figured to move horizontally and vertically in an arc tracking the sun so that at all times it may be at an approximately right angle to the sun's rays.

7. The system of claim 1 wherein the boiler contains a hanex liquid.

8. The system of claim 1 further comprising monitoring system that monitors performance.

9. The system of claim 1 wherein the double chamber scroll compressor is con Figured to boost gas pressure into a second turbine.

10. The system of claim 1 wherein said turbine comprises a first turbine con Figured to propel a scroll compressor unit.

11. The system of claim 9 wherein said turbine comprises a second turbine con Figured to power the generator unit.

12. The system of claim 1 wherein the generator unit comprises squirrel cage micro high revving generator unit.

13. The system of claim 1 further comprises an Air Conditioning Unit comprising a condenser and evaporator.

14. The system of claim 1 further comprising at least one of a hot water heater, a sewage treatment plant, a water purifier, and air conditioner.

15. A solar energy system comprising:
a sun tracking Fresnel lens mounted on a swivel mounted frame;
a support system to support the solar energy system;
a heat exchanger con Figured so that concentrated light from the lens is focused on the heat exchanger;
a turbine arranged in the support system;
a boiler; and
a generator unit arranged in the support system,
wherein the sun tracking lens comprises a circular shape.

16. The system of claim 13 wherein said sun tracking lens is con Figured to move horizontally and vertically in an arc tracking the sun so that at all times it may be at an approximately right angle to the sun's rays.

17. The system of claim 13 wherein the boiler contains a hanex liquid.

18. The system of claim 13 further comprising a monitoring system that monitors performance.

19. The system of claim 13 wherein said turbine comprises a first turbine con Figured to propel a scroll compressor unit.

20. The system of claim 17 wherein said turbine comprises a second turbine con Figured to power the generator unit.

21. The system of claim 1 wherein the generator unit comprises squirrel cage micro generator unit.

22. The system of claim 1 further comprising at least one of a hot water heater, a sewage treatment plant, a water purifier, and air conditioner.
